(19) United States
(12) Patent Application Publication
(10) Pub. No.: US 2014/0359001 A1
(43) Pub. Date: Dec. 4, 2014

(54) MULTIMEDIA DEVICE CONFIGURED TO PROVIDE BOTH CLIENT AND SERVER ASPECTS OF A NETWORK SERVICE

(71) Applicant: Infinite Technologic Corporation (ITC), Toronto (CA)

(72) Inventor: Francois Dupoteau, Toronto (CA)

(21) Appl. No.: 14/312,903

(22) Filed: Jun. 24, 2014

Related U.S. Application Data
(63) Continuation of application No. PCT/CA2012/001170, filed on Dec. 20, 2012.
(60) Provisional application No. 61/582,231, filed on Dec. 30, 2011.
(60) Provisional application No. 61/581,624, filed on Dec. 29, 2011.

(51) Int. Cl. H04L 29/08; H04L 29/06

(52) U.S. Cl. CPC H04L 67/36; H04L 67/42
USPC 709/203

(57) ABSTRACT

A service hosted on a device configured for providing an information resource to a first client, the information resource in web compatible format, The service is configured to receive a request by a service interface of the service for the information resource from a device application hosted by the same device, the device application acting as the first client, such that the request is communicated to the service interface on a communication data path that bypasses a network connection interface of a device infrastructure of the device. The service also accesses by the service interface a service application layer stored on the device in a first storage in order to obtain the information resource. The service also provides the information resource in a response to the first client for subsequent processing and display on a user interface.

### CROSS-REFERENCE TO RELATED APPLICATIONS

This application is a continuation application of PCT International Patent Application No. PCT/CA2012/001170 filed Dec. 20, 2012 which claims priority to U.S. Provisional Application No. 61/582,231 filed Dec. 30, 2011 and 61/581,624 filed Dec. 29, 2011, the contents of which are incorporated herein by reference.

### FIELD

The present invention relates to the provision of client-server relationships

### BACKGROUND

The current use of cloud-based services is based on traditional client-server architecture, such that the cloud-based services are hosted via large numbers of server devices that are remotely located from client devices on a communications network such as the Internet. Typically the cloud-based services provide the client devices with CPU and storage capacities of information resources on demand. Further, the user of traditional cloud-based services has access to applications, storage or administration services through the communications network.

Currently, these remote cloud-based services are optimized to give scalable services to the remote users; however these services are dependant on the type of networks and the quality of the bandwidth connection between the networked devices. For low bandwidth applications the impact of connection quality is marginal but for multimedia applications the impact of connection quality can be important and the quality of service provided by the cloud-based services could be negatively affected. Further, the ability of a user to practically and efficiently provide for server and client functionality on the same device is limited, especially for providing services to both clients on and off of the device (e.g. local device and remote network clients).

Further, there are concerns with respect to the ever-increasing cost of wireless communications, in particular for voice and data plans. Current technology has the ability to implement cost sharing and cost reductions for wireless bandwidth charges, however successful configuration of the technology remains elusive. Today's world has the average user with a number of different household and mobile devices, all with individual service plans that can be overly expensive in the aggregate, such that the service plans for each device typically have overlapping service options with one another.

### SUMMARY

It is an object of the present invention to provide a hosted service to obviate or mitigate at least on of the above-presented disadvantages.

Currently, these remote cloud-based services are optimized to give scalable services to the remote users; however these services are dependant on the type of networks and the quality of the bandwidth connection between the networked devices. For low bandwidth applications the impact of connection quality is marginal but for multimedia applications the impact of connection quality can be important and the quality of service provided by the cloud-based services could be negatively affected. Further, the ability of a user to practically and efficiently provide for server and client functionality on the same device is limited, especially for providing services to both clients on and off of the device (e.g. local device and remote network clients). Contrary to current services, there is provided a service hosted on a device configured for providing an information resource to a first client, the information resource in web compatible format, The service is configured to receive a request by a service interface of the service for the information resource from a device application hosted by the same device, the device application acting as the first client, such that the request is communicated to the service interface on a communication data path that bypasses a network connection interface of a device infrastructure of the device. The service also accesses by the service interface a service application layer stored on the device in a first storage in order to obtain the information resource. The service also provides the information resource in a response to the first client for subsequent processing and display on a user interface.

A first aspect provided is a service hosted on a device configured for providing an information resource to a first client, the information resource in web compatible format, the service stored as instructions for execution by a computer processor of the device to: receive a request by a service interface of the service for the information resource from a device application hosted by the same device, the device application acting as the first client, such that the request is communicated to the service interface on a communication data path that bypasses a network connection interface of a device infrastructure of the device; access by the service interface a service application layer stored on the device in a first storage in order to obtain the information resource; and provide the information resource in a response to the first client for subsequent processing and display on a user interface.

A second aspect provided is a method for hosting a service on a device, the service configured to provide an information resource to a first client, the information resource in web compatible format, the method comprising the steps of: receive a request by a service interface of the service for the information resource from a device application hosted by the same device, the device application acting as the first client, such that the request is communicated to the service interface on a communication data path that bypasses a network connection interface of a device infrastructure of the device; access by the service interface a service application layer stored on the device in a first storage in order to obtain the information resource; and provide the information resource in a response to the first client for subsequent processing and display on a user interface.

A third aspect provided is the service interface communicating with an external device via the network connection interface, the external device located on a communications network connectable to the device infrastructure via the network connection interface.

A fourth aspect provided is the service interface configured as a client of a service provided by the external device.

A fifth aspect provided is service interface obtaining an external information resource from the external device and providing the external information resource as part of the information resource provided to the device application using the communication data path that bypasses the network connection interface.

A sixth aspect provided is wherein the service interface is configured as a service provided to the external device as a client of the service interface.

A seventh aspect provided is a network communication service hosted on a proxy device and configured for facilitating communication of data between a client device of the service on a first network and a network device located on a second network, the service stored as instructions for execution by a computer processor of the proxy device to: receive client content on the first network originating from the client device by a service interface of the proxy device, the client device being a client of the service interface, the client content including a sending address endpoint of the client device on the first network and a destination address endpoint of the network device on the second network, the destination address endpoint associated with a network address of the second network; access by the service interface to a service application layer of the proxy device stored in a first storage in order to identify or otherwise establish a mapping between the address endpoint of the client device and the address endpoint of the network device; configure network transmission data for sending to the destination address endpoint of the network device on the second network, the network transmission data including the client content associated with the client device and the destination address endpoint of the network device; and send via a network connection interface of the proxy device the network transmission data to the network device on the second network; wherein the network transmission data is communicated over the second network using a network service plan for the second network of the proxy device.

An eighth aspect provided is where the service interface obtains service data from the service application layer and includes the service data in the client transmission data.

A ninth aspect provided is where the address endpoints are abstracted using a unique device identification of the client device and a unique device identification of the network device, such that the mapping associates each address endpoint of the address endpoints with the respective unique device identification.

A tenth aspect provided is where the first network is a dedicated short range communication channel incorporating the use of electromagnetic or electrostatic coupling in a radio frequency (RF) portion of an electromagnetic spectrum to uniquely identify and communicate with the client device and the proxy device in electromagnetic spectrum range of one another.

A eleventh aspect provided is a network communication method executed by a proxy device and configured for facilitating communication of data content between a client device on a first network and a network device located on a second network, the method stored as instructions for execution by a computer processor of the proxy device to: receive client content on the first network originating from the client device by a service interface of the proxy device, the client device being a client of the service interface, the client content including a sending address endpoint of the client device on the first network and a destination address endpoint of the network device on the second network, the destination address endpoint associated with a network address of the second network; access by the service interface to a service application layer of the proxy device stored in a first storage in order to identify or otherwise establish a mapping between the address endpoint of the client device and the address endpoint of the network device; configure network transmission data for sending to the destination address endpoint of the network device on the second network, the network transmission data including the client content associated with the client device and the destination address endpoint of the network device; and send via a network connection interface of the proxy device the network transmission data to the network device on the second network; wherein the network transmission data is communicated over the second network using a network service plan for the second network of the proxy device.

### BRIEF DESCRIPTION OF THE DRAWINGS

The foregoing and other aspects will be more readily appreciated having reference to the drawings, wherein:

FIG. 1 shows a service environment for a device configured with a service;

FIG. 2 is a first configuration embodiment of the device of FIG. 1;

FIG. 3 is a second configuration embodiment of the device of FIG. 1;

FIG. 4 is block diagram of the device of FIG. 1;

FIG. 5 is a third configuration embodiment of the device of FIG. 1;

FIG. 6 is an example operation of the device of FIG. 1;

FIG. 7 is a further example operation of the device of FIG. 1;

FIG. 8 is an alternative operational example of the device of FIG. 1; and

FIG. 9 shows an alternative plurality of network configuration of the device of FIG. 1.

### DESCRIPTION

The claimed invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the claimed invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the claimed invention is provided below along with accompanying figures that illustrate the principles of the invention. The claimed invention is described in connection with such embodiments, but the claimed invention is not limited to any embodiment. The scope of the claimed invention is limited only by the claims and the claimed invention encompasses numerous alternatives, modifications and equivalents. Numerous specific details are set forth in the following description in order to provide a thorough understanding of the claimed invention. These details are provided for the purpose of example and the invention may be practiced according to the claims without some or all of these specific details. For the purpose of clarity, technical material that is known in the technical fields related to the claimed invention has not been described in detail so that the claimed invention is not unnecessarily obscured.

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

### Application Access Environment 8

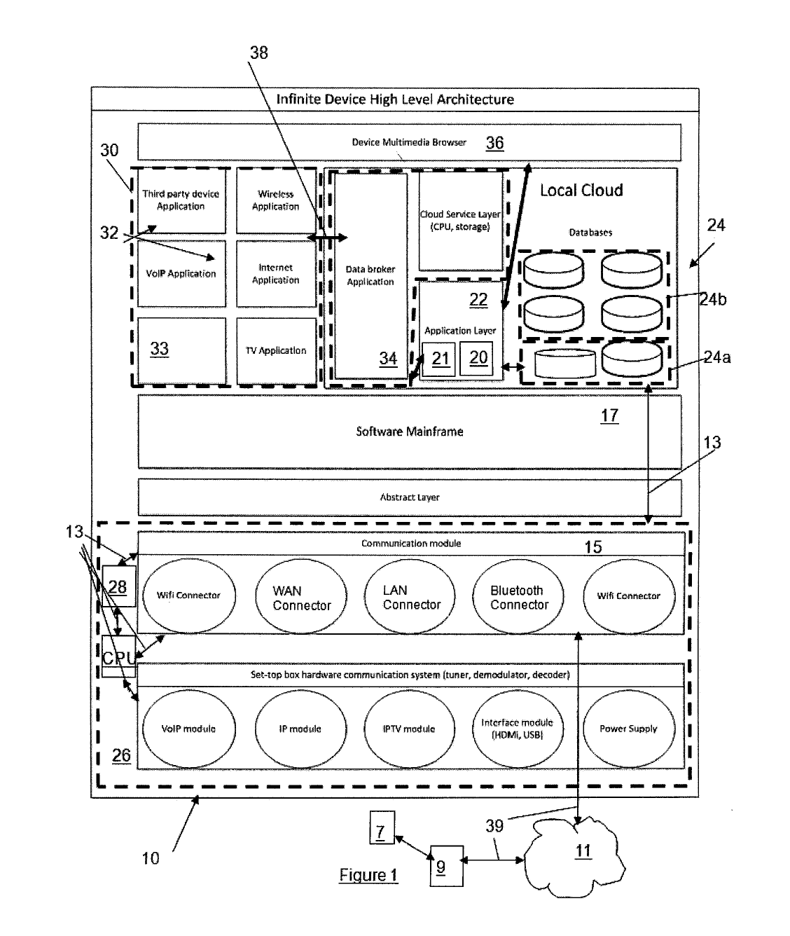

Referring to FIG. 1, shown is a device 10 having an operating system 17 coupled to a device hardware platform 26 (e.g. processor CPU, user interface 28, etc.), whereby the operating system 17 is used by the device user (and other device applications 20) to access and interact with a number of the device applications 20 (and associated application data 21) residing in a device application layer 22 in a local storage 24a (e.g. in-box memory such as an internal hard drive and/or peripheral memory such an external hard drive) of the device 10. As noted below, the operating system 17 can also be used by the device applications 20 to connect with or otherwise utilize other components of a device hardware platform 26 (e.g. external ports or connections 15 to other external devices or networks 11—also referred to as network connectivity interface 15).

The device 10 also has service applications 32 (and associated application data 33) residing in a service application layer 30 in the local storage 24b, such that data content of the storage 24a and 24b remains segregated on the device 10. For example, the storage 24a and storage 24b can be different partitions of a common storage 24 and/or can be represented as different physical storage devices, as desired. In other words, device applications 20 are configured to only access data 21 stored in the storage 24a and are thus restricted from accessing any data 33 stored in the storage 24b. Similarly, the service applications 32 are configured to only access data 33 stored in the storage 24b and are thus restricted from accessing any data 21 stored in the storage 24a. In other words, if the user want to access and interact with any data 33 and/or application 32 services, then the user preferably uses the services of a service interface 34 via a browser application 36. In this manner, the service interface 34 is used by the device 10 to control and coordinate access to information resources (e.g. service applications 32, data 33) located in the service application layer 30. for example, if the browser application 36 wants access to any service resources 32,33, then the browser application 36 must use the service interface 34 for such access.

As noted, access to the service applications 32 (and associated application data 33) is via the service interface 34 (also referred to as a data broker), which can be defined as one of the device applications 20 (i.e. accessible via the operating system 17 and device infrastructure 22—for example the user interface 28). However, it is recognized that the service interface 34 is a specialized device application 20, as only the service interface 34 has access to data 33 and application 32 services located in the service application layer 30 stored in the storage 24b. As such, the other device applications 20 (e.g. including the browser 36) have access to the storage 24a and are thus segregated from accessing the storage 24b unless through the service interface 34.

The device 10 is configured so as to provide the user with access to the service interface 34 via the browser application 36, which can also be defined as one of the device applications 20. Preferably, the service applications 32, the service interface 34, and the browser application 36 are all configured to store, receive and process web compatible formatted content 38 (e.g. data, services, etc.) of the applications 32 and data 33 of the services application layer 30, which can be defined generally as textual, visual or aural content that is encountered as part of the user service application 32 experience accessed via the service interface 34. The web format compatible content 38 can include, among other things: text, images, sounds, videos and animations. Web format compatible content 38 of the service applications 32, as brokered by the service interface 34 between the service applications 32 and the browser application 36, can include documents, data, applications, e-services, images, audio and video files, personal Web pages, archived e-mail messages, and more.

The device 10 is also configured to communicate with other external devices 9 located on the communications network 11, such that the device 10 can have network access to services and/or data 7 provided by the external devices 9. Access of the device applications 20 (e.g. service interface 34 and browser application 36) to the external devices 9 is provided by the operating system 17 and associated network components (e.g. network interface 15 of the device platform 26), via the communications network 11. The services and/or data 7 provided by the external devices 9 can be configured as web based content 39 (e.g. data, services, etc.), which can be defined generally as textual, visual or aural content that is encountered (e.g. sent or received) by the service interface 34 and/or the browser application 36. The web format content 39 can include, among other things: text, images, sounds, videos and animations. Web format compatible content 39 of the services and/or data 7 provided by the external devices 9, as brokered by network connection interface 15 between the service interface 34 or the browser application 36, can include documents, data, applications, e-services, images, audio and video files, personal Web pages, archived e-mail messages, and more. As such, the service interface 34 brokers access to the web format compatible content of the service application layer 30, which can be accessed by the browser application 36 when bypassing the network connection interface 15. As further described below, the network connection interface 15 brokers access to the service interface 34 (and ultimately the service application layer 30) for devices 9 located external to the device 10 on the network 11.

For example, the device 10 can be a computing device 10 employed by a device user (e.g. a personal computing device). Examples of the device 10 can include such as but not limited to: a mobile device; a smart phone, a wireless phone; a PDA; a tablet; and/or a desktop computer. Also envisioned is a server configured computer device 10. Accordingly, the computing device 10 can be connected to the network 11 via a wireless connection. Accordingly, the computing device 10 can be connected to the network 11 via a wired connection.

### Operating System 17

The operating system (OS) 17 can be defined as a collection of software that manages computer hardware resources of the device infrastructure 26 and provides a common services platform for device applications 20 installed on the device 10. Device applications 20 use the operating system 17 to provide their application specific functionality (e.g. application data processing via the CPU, data persistence in the storage 24, communication/interaction of data via the network interface 15, and/or interaction with the device user via a user interface 28 (e.g. touch screen). The operating system 17 can also be configured to implement scheduling of tasks for efficient use of the device infrastructure 26 and can also include accounting for cost allocation of processor CPU time, mass storage, printing/display, and other resources.

As such, the device applications 20 are configured to use the operating system 17 in order to access any of the hardware of the device infrastructure 26, whether it be as simple as a mouse or keyboard or as complex as interaction with server 9 functionality over the network 11. The operating system 17 provides an interface between the device applications 20 and the computer hardware of the device infrastructure 26, so that the device applications 20 can interact with the hardware only by obeying rules and procedures programmed into the operating system 17. The operating system 17 can be defined as a set of services which simplify development and execution of device applications 20. As discussed below, executing the device applications 20 (e.g. accessing the application 20 functionality by the device 10 with or independently from the device user) involves the creation of a process by the operating system 17 kernel, which can assign memory 24 space and other resources, establish a priority for the process in multi-tasking systems, load program binary code into memory 24, and/or initiate execution of the device applications 20 which then interacts with the user and with other hardware devices of the device infrastructure 26.

For hardware functions such as input and output and memory allocation, the operating system 17 acts as an intermediary between device applications 20 and the computer hardware (e.g. the device infrastructure 26), although the application code of device applications 20 is usually executed directly by the hardware (e.g. CPU) and the application code can make a system call to an operating system 17 function or be interrupted by an operating system 17 function. Interrupts via the operating system 17 can provide an efficient way for the operating system 17 to interact with and react to its environment. A device application 20 may trigger an interrupt to the operating system 17, for example if the device application 20 wishes to access hardware the device application 20 may interrupt the operating system's 17 kernel, which causes control to be passed back to the kernel. The kernel will then process the request. If the device application 20 wishes additional resources (or wishes to shed resources) such as memory 24a, the device application 20 will trigger an interrupt to get the kernel's attention.

The kernel of the operating system 17 connects the device application 20 software to the hardware (e.g. device infrastructure 26) of the device 10. With the aid of the firmware and device drivers stored in the storage 24a, the kernel can provide the most basic level of control over all of the hardware devices of the device infrastructure 26. The operating system 17 (via the kernel) can manage memory 24a access for device applications 20 in the RAM, can determine which device applications 20 get access to which hardware resources, can set up or resets the CPU's operating states for optimal operation, and can organize the data for long-term non-volatile storage with file systems in the storage 24a media. The operating system 17 can also support multiple modes of operation, e.g. protected mode and supervisor mode. The supervisor mode is used by the operating system's 17 kernel for low level tasks that need unrestricted access to hardware, such as controlling how memory is written and erased, and communication with devices like graphics cards. Protected mode, in contrast, can be used by the device applications 20 to facilitate access to desired hardware by communicating with the kernel, which controls such access via the supervisor mode.

Examples of the operating system 17 can include a real-time operating system that is a multitasking operating system that aims at executing real-time device applications 20. Real-time operating systems 17 can use specialized scheduling algorithms so that they can achieve a deterministic nature of behavior. An objective of real-time operating systems 17 is their timely and predictable response to device application 20 events. Another objective of real-time operating systems 17 is their timely and predictable response to user events of the user via the user interface 28. Operating systems 17 can have an event-driven or time-sharing design and often aspects of both. An event-driven system switches between tasks based on their priorities or external events while time-sharing operating systems switch tasks based on clock interrupts. Another example of the operating system 17 is an embedded operating systems designed to be used in embedded computer systems, such as smaller machines such as PDA versions of the devices 10 with less autonomy. Embedded operating system 17 can be configured to operate with a limited number of resources, can have a compact memory footprint, and can be highly optimized for the device infrastructure 26. Windows CE and Minix 3 are some examples of embedded operating systems 17.

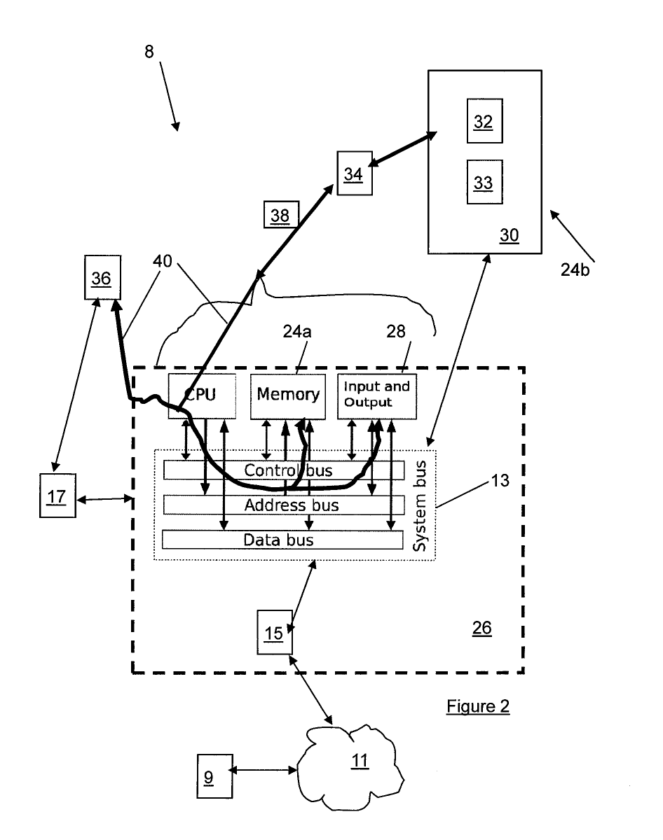

As such, as shown in FIG. 2, the operating system 17 uses components of the device infrastructure 26 to facilitate communication of the browser application 36 (i.e. a device application 20) with the service interface 34 using a data communication path 40 (e.g. using system bus 13 addressing) that bypasses the network connection interface 15 of the device infrastructure 26

### Device Infrastructure 26

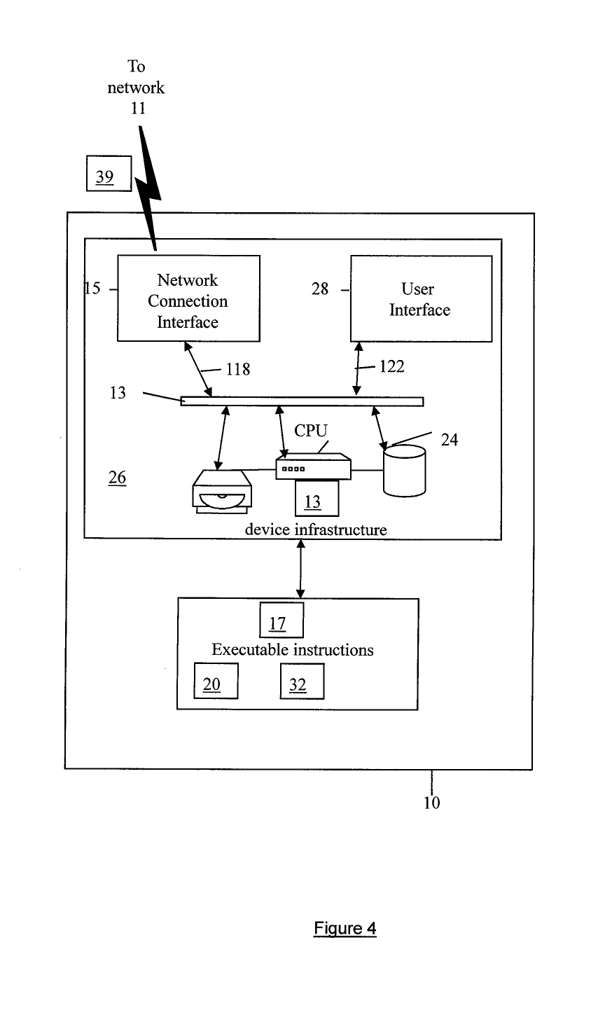

Referring to FIG. 4, shown is an example device infrastructure 26 including the network connection interface 15, such as a network interface card (e.g. SIM) or a modem, coupled via connection 118 to a system bus 13. The network connection interface 15 is connectable during operation of the devices 10 to the network 11 (e.g. an intranet and/or an extranet such as the Internet), which enables the devices 9,10 to communicate with each other as appropriate. The network 11 can support the communication of the content data 39, and the related content.

Referring again to FIG. 4, the device 10 can also have the user interface 28, coupled to the system bus 13 by connection 122, to interact with a user (not shown). The user interface 28 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 26.

Referring again to FIG. 4, operation of the device 10 is facilitated by the device infrastructure 26. The device infrastructure 26 includes one or more computer processors CPU and can include associated memory 24. The computer processor CPU facilitates performance of the device 10 configured for the intended task (e.g. of the respective module(s) of applications 20,32) through operation of the network interface 15, the user interface 28 and other application programs/hardware of the device 10 by executing task related instructions. These task related instructions can be provided by the operating system 17, and/or software applications 20,32 located in the memory 24a,b, and/or by operability that is configured into the electronic/digital circuitry of the processor(s) CPU designed to perform the specific task(s). Further, it is recognized that the device infrastructure 26 can include the computer readable storage medium 24 coupled to the processor CPU for providing instructions to the processor CPU and/or to load/update the instructions. The computer readable medium 24 can include hardware and/or software such as, by way of example only, flash memory, optically readable medium such as CD/DVD ROMS, and memory cards. In each case, the computer readable medium 24 may take the form of a small disk, hard disk drive, solid-state memory card, or RAM provided in the memory module 24. It should be noted that the above listed example computer readable mediums can be used either alone or in combination.

Further, it is recognized that the computing device 10 can include the executable applications 20,32 of the respective application layers 22,30 comprising code or machine readable instructions for implementing predetermined functions/operations including those of an operating system and the modules, for example. The processor CPU as used herein is a configured device and/or set of machine-readable instructions for performing operations as described by example above, including those operations as performed by any or all of the applications 20,32 firmware and/or operating system 17. As used herein, the processor CPU may comprise any one or combination of, hardware, firmware, and/or software. The processor CPU acts upon information by manipulating, analyzing, modifying, converting or transmitting information for use by an executable procedure or an information device, and/or by routing the information with respect to an output device. The processor CPU may use or comprise the capabilities of a controller or microprocessor, for example. Accordingly, any of the functionality of the modules may be implemented in hardware, software or a combination of both. Accordingly, the use of a processor CPU as a device and/or as a set of machine-readable instructions is referred to generically as a processor/module for sake of simplicity.

The system bus 13 can have the functions of a data bus to carry information, an address bus to determine where it should be sent, and a control bus to determine its operation. The address bus functionality (e.g. a series of lines connecting two or more components of the device platform 26) is used to specify a respective physical device address of each the components of the device platform 26 (i.e. each endpoint of a data path 40—see below and FIG. 2). For example, when a processor CPU or I/O device 15,28 needs to read or write to a memory 24 location, it specifies that memory location on the address bus (the value to be read or written is sent on the data bus).

### Network 11 and Network Data 39 Communication

Preferably, the communications network 11 comprises a wide area network such as the Internet, however the network 11 may also comprise one or more local area networks 11, one or more wide area networks, or a combination thereof. Further, the network 11 need not be a land-based network, but instead may comprise a wireless (e.g. Bluetooth, Wifi, etc.) network and/or a hybrid of a land-based network and a wireless network for enhanced communications flexibility. The communications network 11 is used to facilitate network interaction between the devices 10 and the external devices 9. In terms of communications on the network 11, these communications can be between the computer devices (e.g. device 10 and device 9) consisting of addressable network packages following a network communication protocol (e.g. TCPIP), such that the network 11 address of the packets (e.g. in the packet header to facilitate packet transmission/routing over the network 11) for the data content 39 includes a network 11 address of the external device 9 and/or the network 11 address of the device 10.

As such, the communication protocol (e.g. TCP/IP) of the packets provides end-to-end connectivity (as defined by the sending and receiving network 11 addresses) specifying how the data content 39 should be formatted, addressed, transmitted, routed and received at the destination network address. As such, the network 11 address(s) included in the packets for the data content 39 provides for routing of the packets external to the device 10 on the communications network 11. It is recognized that the connection of the device 10 to the network 11 is facilitated via the network connection interface 15. Examples of the interface 15 can include a specified country and network connectivity interface 15—e.g. SIM card—of the device hardware platform 26. Alternatively, the network connection interface 15 can be network interface controller (also known as a network interface card, network adapter, LAN adapter and by similar terms), which is a computer hardware component that connects the computer device 10 to the computer network 11 (e.g. wired or wireless connection). The network interface 15 can include controllers implemented on expansion cards that plug into the system bus 13 as well as a network interface 15 built into the motherboard (not shown) coupling the processor CPU, storage 24 and other hardware components via the system bus 13.

Further, it is recognized that the network connection interface 15 is also coupled to a plurality of ports, whereby in computer networking a port is an application-specific or process-specific software construct serving as a communications endpoint of the network 11 in the host operating system 17. A port can be associated with an IP address of the device 10, as well as the type of network 11 protocol used for communication of the content data 39. The purpose of ports is to uniquely identify by the operating system 17 the different applications 20 or processes 20 running on the device 10 and thereby enable the device applications/processes 20 to share a physical connection of the network connection interface 15 to the network 11 (e.g. a packet-switched like the Internet), via which the content data 39 is transmitted and received between the devices 9,10.

Example communication protocols of the operating system 17 that primarily use ports of the network connection interface 15 are Transport Layer protocols, such as the Transmission Control Protocol (TCP) and the User Datagram Protocol (UDP) of the Internet Protocol Suite. Each port can be identified for each address and protocol by a 16-bit number, commonly known as the port number. The port number, added to the device's 10 IP address, completes the destination address (e.g. for device 9,10) for a communications session between the devices 9,10 over the external communications network 11. That is, data packets of the data content 39 are routed across the network 11 to a specific destination IP address, and then, upon reaching the destination device 9,10, are further routed to the specific process (e.g. device application 20) bound to the destination port number. As such, the data content 39 is requested and received by the device applications 20 (e.g. service interface 34, browser 36) with respect to the external network 11 via the network interface 15 (e.g. using appropriate ports configured by the operating system 17).

It is noted that the combination of IP address and port number together is globally unique. Thus, different IP addresses or protocols can use the same port number for communication; e.g., on a given host or interface UDP and TCP can use the same port number, or on a host with two interfaces, both addresses can be associated with a port having the same number. For example, of the thousands of enumerated ports, about 250 well-known ports are reserved by convention to identify specific service types on the host device 10. In the client-server model of application architecture used by the device 10 via the network interface 15 (e.g. the device application 20 is configured as a client of an external device 9 providing server functionality or the device application 20 is configured as a server of an external device 9 providing client functionality), ports can be used to provide a multiplexing service on each server-side port number that network clients connect to for service initiation, after which communication can be reestablished on other connection-specific port numbers.

Transport Layer protocols employed by the ports and network interface 155, such as the Transmission Control Protocol (TCP) and the User Datagram Protocol (UDP), can specify a source and destination port number in their packet headers of the content data 39. Accordingly, the device application 20 (e.g. browser application 36 or service interface 34) associates its input or output channels via Internet sockets, a type of file descriptor, with a transport protocol, a port number and an IP address. This process is known as binding, and provides the device applications 20 to send and receive content data 39 via the external network 11.

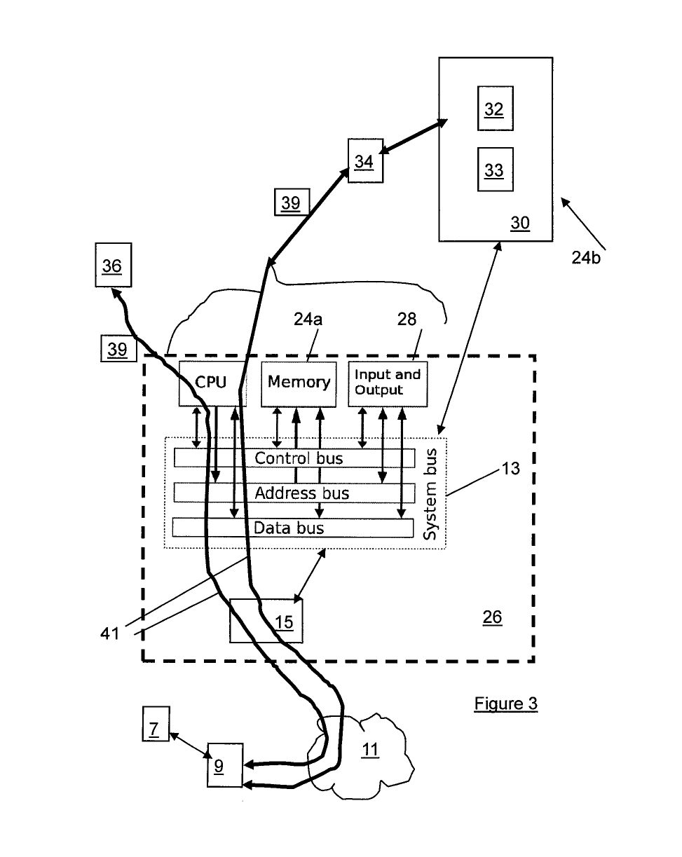

In general, the service applications 32 and corresponding data 33 can be referred to generically as service resources 32,33 (also referred to as data content 38), as a fundamental element accessed via the service application layer 30. The service resources 32,33 can be accessed via the service interface 34 via a data communication path 40 (see FIG. 2) that bypasses the network connection interface 15 of the device 10. For example, the service resources 32,33 can refer to targets of Uniform Resource Locators (URLs), Uniform Resource Identifier (URI) or Internationalized Resource Identifier (IRI), as long as access on the device 10 (e.g. between browser 36 and service interface 34) uses the data communication path 40 to access such service resources 32,33. As further described below, the service resources 32,33 can also be accessed by the external devices 9, by addressing the service interface 34 via the external network 11 coupling the external devices 9 and the service interface 34 via the network connection interface 15. In this manner, the service resources 32,33 are referred to as data content 39 when they are communicated through the network connection interface 15 (e.g. between devices 9,10 over the network 11), also referred to as data communication path 41 (see FIG. 3).

It is also recognized that for communications in which the device 10 is a client of an external device 9 on the network 11 (e.g. browser 36 is the client of a service offered by the device 9), the applications and data 7 offered by the device 9 can be referred to as network 11 resources (also referred to as data content 39), as a fundamental element accessed via the application layer 22. The network 11 resources can be accessed via the network connection interface 15 via the data communication path 41 (see FIG. 3) provided by the network connection interface 15 of the device 10. For example, the network 11 resources can refer to targets of Uniform Resource Locators (URLs), Uniform Resource Identifier (URI) or Internationalized Resource Identifier (IRI), as long as access off the device 10 (e.g. between browser 36 and device 9) uses the data communication path 41 to access such network 11 resources. In this manner, the network 11 resources are referred to as data content 39 when they are communicated through the network connection interface 15 (e.g. between devices 9,10 over the network 11), also referred to as data communication path 41 (see FIG. 3).

As such, the concept of an information resource (e.g. service resource referred to as data content 38/information resource 38 or network resource referred to as data content 39/information resource 39) can refer to static addressable documents or files, or to a more generic and abstract definition, now encompassing every thing or entity that can be identified, named, addressed or handled, in any way whatsoever. An information resource 38,39 can be anything that has identity. Familiar examples include an electronic document, an image, a service (e.g., service provided by applications 20,32), and a collection of other resources. In this manner, the information resource 38,39 is referred to as data content 38 when communicated on the data communication path 40 (see FIG. 2) and data content 39 when communicated on the data communication path 41 (see FIG. 3). Data content 39 can also be referred to as Web content and data content 38 can also be referred to as Web format compatible content, both of which are consumable by the browser 36.

### Browser 36

Referring to FIGS. 2 and 3, the browser 36 can be a software application for retrieving, presenting and traversing information resources (e.g. content 38,39) obtained via communications paths 40,41 (e.g. path 41 uses the network 11 as access to resources on the World Wide Web—Internet). The information resource 38,39 can be identified by a Uniform Resource Identifier (URI) and can be a web page, image, video or other piece of content. Hyperlinks present in information resource 38,39 provide for users to navigate their browsers 36 to related information resource 38,39. The browser 36 is configured to process web compatible format content 38,39 and can also be defined as an application software or program designed to provide users to access, retrieve and view documents and other information resource 38,39 on the network 11 and/or via the service interface 34. Although browsers 36 are primarily intended to use the World Wide Web (e.g. network 11), browsers 36 can also be used to access information resource 38 provided by the service interface 34 for data content 38 stored in files of file systems in the storage 24b. Examples of browsers 36 are device applications 20 such as but not limited to Chrome, Firefox, Internet Explorer, Opera, and Safari. As such, the browser application 36 is a specialized device application 20 that can access both the data content 38 via the communication path 40 and the data content 39 via the communication path 41. The data content 38,39 is preferably in the format of web pages that can contain text, images, videos, and other multimedia, as well as provide for navigation between the page content and the pages themselves via hyperlinks. Accordingly, the browser application 36 is configured to process data content 38,39 as “hypertext documents” to be viewed/manipulated using a client-server architecture (e.g. the browser 36 is a client of the service interface 34 for data content 38 and a client of the device(s) 9 for the data content 39).

The browser 36 can have a number of user interface elements in common. For example, back and forward buttons to go back to the previous resource and forward respectively via the communication path 40,41. A refresh or reload button to reload the current information resource 38,39. A stop button to cancel loading the information resource 38,39. In some browsers 36, the stop button is merged with the reload button. A home button to return to the user's home page, for example hosted by the service interface 34. An address bar to input the resource addresses (e.g. Uniform Resource Identifier (URI) associated with the network connection interface 15 or a system bus 13 address) of the desired information resource 38,39 and display it. A search bar to input terms into a search engine. In some browsers 36, the search bar is merged with the address bar. A status bar to display progress in loading the information resource 38,39 and also the resource address of links when the cursor hovers over them, and page zooming capability. Major browsers 36 also possess incremental find features to search within a page of the content of the information resource 38,39.

The primary purpose of a browser 36 is to bring information resources 38,39 to the user (“retrieval” or “fetching”), allow them to view the information resource 38,39 (“display”, “rendering”), and then access other information (“navigation”, “following links”) associated with the current information resource 38,39.

This process begins when the user inputs a resource address (e.g. Uniform Resource Locator (URL) or system bus 13 address) into the browser 36, which is then processed by the browser 36 to fetch the information resource 38,39 located at the respective resource address. In terms of the browser 36 for data path 40 addresses, the browser 36 can be configured to convert data path address 41 to data path address 40 in order to access the service interface 34 via the data path 40 when the browser 36 is configured as a local device application 20 accessing the service interface 34 locally (e.g. not located on the network 11 remote from the device 10 and thus forced to use the network connection interface 15). A portion of the resource address (e.g. the prefix of the URL, the Uniform Resource Identifier or URI) determines how the resource address can be interpreted by the browser 36. The browser 36 can support a variety of other prefixes, such as https: for HTTPS and ftp: for the File Transfer Protocol via the data path 41, and file: for local files via the data path 40. Prefixes that the browser 36 cannot directly handle can be handed off to another application 20 entirely. For example, mailto: URIs can be passed to the user's default e-mail application 20, and news: URIs can be passed to the user's default newsgroup reader application 20.

In the case of http, https, file, and others, once the information resource 38,39 has been retrieved (either acting as a client of the service interface 34 via the data path 40 or as a client of the external device 9 via the data path 41), the browser 36 can display the information resource 38,39 on the user interface 28. HTML and associated content (image files, formatting information such as CSS, etc.) of the information resource 38,39 can be passed to the browser's 36 layout engine to be transformed from markup of the content 38,39 to an interactive document, a process known as “rendering”. Aside from HTML, web format compatible browsers 36 can generally display any kind of web compatible format content of the information resource 38,39 that can be part of a displayed page content 38,39. The browser 36 can display images, audio, video, and XML files, and often have plug-ins to support Flash applications and Java applets. Upon encountering a file of an unsupported type or a file that is set up to be downloaded rather than displayed of the information resource 38,39, the browser 36 can prompt the user to save the file information resource 38,39 to storage 24. Further, information resources 38,39 can contain hyperlinks to other information resources 38,39. Each link can contains the resource address (e.g. URI) of a resource 38,39 to go to. When a link is clicked, the browser 36 navigates to the information resource 38,39 indicated by the link's target resource address, and the process of bringing content to the user begins again. As such, the user can access the information resource 38 via the data path 40 and the information resource 39 via the data path 41.

For communications with external devices 9, content served to them by the service interface 34 (from service applications 32 and data 33) via the network interface 15 is referred to as information resources 39 or data content 39. However, for communications with device applications 20, content served to them by the service interface 34 (from service applications 32 and data 33) bypassing the network interface 15 (e.g. via the system bus 13) is referred to as information resources 38 or data content 38.

### Web Format Compatible Content 38,39

One example of web compatible format for the content 38,39 is HyperText Markup Language (HTML) as an example markup language for displaying page content 38,39 and other information 38,39 that can be displayed on the user interface 28 via the browser 36. HTML formatted content 38,39 is written in the form of HTML elements consisting of tags enclosed in angle brackets (like <html>), within the page content. HTML tags most commonly come in pairs like <h1> and </h1>, although some tags, known as empty elements, are unpaired, for example <img>. The purpose of the browser 36 is to read or otherwise process the web compatible format (e.g. HTML documents) and compose them into visible or audible pages as displayed on the user interface 28. The browser 36 does not display the HTML tags, but uses the tags to interpret the content 38,39 of the page. The web compatible format (e.g. HTML elements) form the building blocks of content. Web compatible format (e.g. HTML) allows images and objects to be embedded and can be used to create interactive forms. Web compatible format provides a means to create structured documents of the content 38,39 by denoting structural semantics for text such as headings, paragraphs, lists, links, quotes and other items. Web compatible format can embed scripts in languages such as JavaScript which affect the behavior of the pages of the content 38,39. The browsers 36 can also refer to Cascading Style Sheets (CSS) to define the appearance and layout of text and other material of the content 38,39. Other web compatible formats for the content 38,39 can preferably include HTML5. Still other web compatible formats for the content 38,39 can include XHTML, XML, and SGML. It is recognized that the various web compatible formats for markup language can include several components, including elements (and their attributes), character-based data types, character references and entity references. Another component is the document type declaration, which triggers standards mode rendering.

The web compatible formats of the content 38,39 (e.g. HTML type formatting—for example HTML5) can be composed primarily of documents transmitted from a service (e.g. web servers 9 for content 39 via data path 41 and service interface 34 for content 38 via data path 40) using the appropriate messaging protocol (e.g. Hypertext Transfer Protocol (HTTP) or system bus 13 addressing). However, web compatible formats can be used to serve images, sound, and other content, in addition to documents. To provide for the browser 36 to know how to handle each content 38,39 it receives, other information (e.g. meta data) is transmitted along with the content 38,39. This meta data can include a MIME type (e.g. text/html or application/xhtml+xml) and character encoding embedded as part of the content 38 received via the data path 40. This meta data can include a MIME type (e.g. text/html or application/xhtml+xml) and character encoding embedded as part of the content 39 received via the data path 41.

### Example Data Communication Path 40

Referring again to FIGS. 1 and 2, shown is an example configuration of a communications network 11 having one or more of the devices 10 and network available external devices 9 (e.g. which could be configured similarly to devices 10, could be computer devices 9 and/or could be servers 9, as desired). Each of the external devices 9 can have at least one application (e.g. example providing services and/or data source 7) running on the device 9 and can communicate with the device 10 over the network 11, such that the device 10 can have network access to the services and/or data 7 provided by the external remote devices 9. In terms of remote communications over the network 11, as enabled via the device network connection interface 11, the device 10 can provide for these communications (e.g. access to the services and/or data 7) using network 11 communication configured device applications 20 (e.g. the service interface 34, browser application 36). For example, a first remote server 9 is configured to communicate (via the device network interface 15 over the external communications network 11) with the device 10 via a first client application 20 (e.g. a device application 20 that was installed and/or is managed by the first server 9, alternatively the browser application 36) and a second remote server 9 (or same first server 9) is configured to communicate (via the device network interface 15 over the external communications network 11) with the device 10 via a second client application 20 (e.g. the service interface 34), such that the first application 20 (e.g. browser application 36) is not configured (i.e. restricted) to communicate as a client of the server 9 with access to the application services and data 33 stored in the storage 24b and the second application 20 (e.g. the service interface 34) is not configured (i.e. restricted) to communicate as a client of the server 9 with access to the application services and data 21 stored in the storage 24a. In other words, the first application 20 (e.g. browser 36) can be in a client-server relationship with the remote server 9 (e.g. first) and the second application 16 (e.g. the service interface 34) can be in a client-server relationship with the remote server 9 (e.g. second).

Further, the service interface 34 is configured to provide access to the web format compatible content 38 of the service applications 32 to the browser 36, such that the communication of the web format compatible content 38 is on the local device data path 40 that bypasses the network connection interface 15 used to access the external network 11. In this manner, both the endpoint address of the service interface 34 and the endpoint address of the browser application 36 (for purposes of web format compatible content 38 communication) are restricted from being network 11 addresses recognized by the network connection interface 15). For example, the local device data path 40 can be via a file system of the device application layer 22 (e.g. via a short cut such as (C://type).

Referring to FIGS. 2 and 3, specifically, the local device data path 40 used to communicate the web format compatible content 38 between the service interface 34 and the browser 36 is separate from a traditional loopback interface path 41 (leveraging use of network connection interface 15). In general terms, the loopback interface path 41 can be used by network client software (e.g. device applications 20) on the device 10 to communicate with server type software and functionality (e.g. the service interface 34) on the same computer device 10, namely on the computer running the web enabled server, or service (e.g. the service interface 34) pointing the web browser 36 to the loopback interface path 41 network address (e.g. URLs http://127.0.0.1/ or http://localhost/can access that computer's own web site). In TCP/IP, a loopback device can be a virtual network interface path 41 implemented in software only and not connected to any hardware, but which is fully integrated into the computer system's internal network infrastructure including the network connection interface 15. Any communication that a computer program 20 sends to the loopback interface path 41 is immediately received on the same interface path 41. Correspondingly, the Internet Protocol (IP) specifies a loopback network interface path 41. In IPv4 this can be the loopback interface path 41 with the CIDR prefix 127.0/8. The most commonly used IP address on the loopback interface 41 is 127.0.0.1 for IPv4, although any address in the range 127.0.0.1 to 127.255.255.254 is mapped to it. IPv6 designates only a single address for this loopback network interface path 41 function, 0:0:0:0:0:0:0:1 (also written as ::1), having the ::1/128 prefix. The standard, officially reserved, domain name for these addresses of the loopback network interface path 41 can be localhost. On Unix-like systems, the loopback interface path 41 usually has the device name lo or lo0. Accordingly, a loopback interface path 41 has several uses, including use by network client software configured applications 20 (e.g. browser application 36) on the device 10 to communicate with server software (e.g. service interface 34) on the same computer device 10, namely on the device 10 running both the browser application 36 and the service interface 34 (e.g. enabled to emulate the functionality of a traditional web server).

Pointing the web browser application 36 to the URLs http://127.0.0.1/ or http://localhost/ will access that computer device's 10 own web compatible format content 38 (e.g. web site). This works without any actual external network 11 connection (e.g. with one of the external devices 9), so it can be useful for testing services of the service interface 34 without exposing them to security risks from remote network access of external devices 9 via the network connection interface 15. Likewise, pinging the loopback interface path 41 can be a basic test of the functionality of an IP stack provided by the operating system 17, such that the IP stack also cooperates in providing for the loopback interface path 41. Further, it is recognized that packets containing the content 38 sent in the IP network 11 with a source address (associated with the IP network 11) belonging to the loopback interface path 41 can cause a number of problems for older or buggy network software. Such packets can be known as ‘martian packets’ and the source addresses of these packets can be collectively known as ‘bogons’. The Internet Protocol specification dictates that such packets must not be transmitted outside of the host device 10, and must be dropped if received on the network interface 15 for communication on the network 11 external to the device 10.

As such, in terms of communications of the data content 38 locally within the device 10 (e.g. using a system bus 13 of the device platform 26) on the network 11, these communications can be between the device applications 20 (e.g. browser application 36 and service interface 34) on the device 10 (i.e. intra-device) rather than between remote computer devices 9,10 (i.e. extra-device). the system bus 13 can be defined as a computer bus that connects the major components of the computer device platform 26 to one another (e.g. processor CPU, storage 24, and I/O devices such as user interface 28 and network interface 15). The system bus 13 can have the functions of a data bus to carry information, an address bus to determine where it should be sent, and a control bus to determine its operation. The address bus functionality (e.g. a series of lines connecting two or more components of the device platform 26 used to define that data path 40) is used to specify a respective physical device address of each the components of the device platform 26 (i.e. each endpoint of the data path 40). For example, when a processor CPU or I/O device 15,28 needs to read or write to a memory 24 location, it specifies that memory location on the address bus (the value to be read or written is sent on the data bus). In terms of the segregated storages 24a,b, the individual device applications 20 keep track of their respective memory address(es) in their respective storages 24a,b. As such, data 33 that comes from storage 24b via service interface 34 can be transferred to browser application 36 over the system bus 13 for storage as data 21 in storage 24a, using the respective physical device addresses defined on the system bus 13 for the data path 40. Similarly data 21 that comes from storage 24a via browser application 36 can be transferred to service interface 34 over the system bus 13 for storage as data 33 in storage 24b, using the respective physical device addresses defined on the system bus 13 for the data path 40.

Therefore, data content 38 communication consists of addressable data packages following a system bus 13 communication, such that the device addresses for the data content 38 includes a device address (e.g. of the storage 24b) used by the service interface 34 and/or the device address (e.g. of the storage 24a) used by the browser application 36. As such, the communication path 40 via the computer bus 13 between storages 24a,b provides end-to-end connectivity (as defined by the source and destination device addresses) specifying how the data content 38 should be formatted, addressed, transmitted, routed and received at the destination device address. As such, the device address(s) for the data content 38 provides for routing of the data content 38 internal to the device 10 on the system bus 13.

### Service Interface 34

The service interface 34 provides a system to manage, distribute and store multimedia data 33 and corresponding service applications 32 in a service application layer 30 of the device 10, based on a local web format compatible services architecture. As such, the service interface 34 and service application layer 30 can be referred to as a “local cloud” embedded in the multimedia device 10. Further examples of the device 10 can be a multimedia set-up box, an ADSL router or a Wifi configured device or a network 11 connected device. Operation of the service interface 34 is advantageous in that it provides a method to manage, distribute and store multimedia data 33 and services 32 based on the local cloud services architecture, whereby the operation of the service interface 34 can provide the possibility to share web format compatible content 38 (e.g. multimedia files and messages and other content) via the local cloud services architecture between various types of external multimedia devices 9,10 on the network 11 (see FIG. 3), as well as between local device applications 20 (e.g. with the browser 36) when not on the network 11 (see FIG. 2). The web format compatible content 38 could contain video, audio, image, text or any kind of files supported by the multimedia devices 9,10.

The service interface 34 and service application layer 30 can provide the services of: 1) scalable applications 32 services; 2) scalable data 33 storage 24b services; and 3) scalable network and bandwidth optimization (i.e. efficient management of the network connection interface 15) by using either the data path 40 or data path 41 depending upon whether the client is the local browser 36 or an external device 9. The service interface 34 can provide management functions and features for: 1) Internet 11 connectivity optimization between the client browser 36 or between the client devices 9; 2) storage device 24b for multimedia files (e.g. service resources 32,33); 3) framework and middleware access of device infrastructure 26 for service distributed applications 32; and 4) registration (e.g. user account and login privileges for the client browser 36 and client devices 9).

Types of transactions managed by service interface 34 can include: 1) local application 36 with local multimedia file(s) 32,33 of the service interface 34; 2) local application 36 with hybrid transaction from local multimedia file 32,33 and external data 7 (from Internet or outside network 11 from devices 9), such that the data path connection between the browser 36 and the service interface 34 is data path 40 while the data path connection between the service interface 34 and the external device 9 is data path 41—as such the browser 36 can receive content 38 via the system bus 13 as well as content 39 via the system bus 13 that is brokered by the service interface 34 between the device 9 and the browser 36); 3) streaming data 38 of external data 39 (from Internet or outside network 11) to the local application 36; 4) third party application 7 (from non register device 9) with local application 20; and 5) third party application 7 (from non register device 9) with hybrid transaction supplying local content 38 from services application layer 30 and external data content 39 (from Internet or outside network 11) from device 9.

The structure of the service interface 34 and the services application layer 30 can include: 1) local cloud application 32 services for: a. CPU Applications; b. Storage Applications; c. Services Applications; d. Administration of customers Applications; e. Streaming Applications; f. Wireless Applications; g. Third party management Applications. The service interface 34 can also be configured to manage connections (e.g. via the system bus 13) to the network connection interface 15 as well as for accessing and storage of data 33 for local cloud databases 24b (e.g. Multimedia Database, Application Database, Devices Database, Customers Database, Transaction Database).

The service interface 34 manages all content of the services application layer 30 (e.g. for applications 32 downloaded by the device user or pushed by a third party application 32 provider—example app 32 purchased by the user and then configured as part of the services application layer 30). The applications 32 downloaded via the network connection interface 15 are installed and configured in the services application layer 30 via the service interface 34 acting as the application 32 management system. The service interface 34 is in charge to optimize the integration inside the services application layer 30 (e.g. local cloud) of the new application 32. After installation, the applications 32 can be accessed from the various databases 24b (based on user supplied login and access credentials to the service interface 34) to access the processor CPU and via the data broker the applications 32 and associated data 33 of the storage 24b.

The service interface 34 can have a number of different functions, such as running as a private content 38 service in which the information resources 32,33 are stored in a private section of the storage 24b that is not accessible to anyone else. In the private section of the storage 24b, the device user stores his private applications 32 such as banking information, home monitoring applications, private images and video storage. As such, it is envisioned that only the device user with appropriate user credentials (e.g. user name and password) could access the private section of the storage 24b either by the client browser 36 (once the user account credentials—for example name and password—is verified by the service interface 34) or a client device 9 used by the device user (once the user account credentials are verified by the service interface 34). Otherwise, access to the private section of the storage 24b could be restricted to the client browser 36 with appropriate verified user account credentials, i.e. machine locked access as only device browsers 36 can access the service interface 34 and not device 9 browsers coming in via the network connection interface 15.

Access to the service interface 34 (and managed service application layer 30) could be provided as a public or semi public service. In this embodiment, the user can give access to the applications 32,33 hosted by the service interface 34 to a third party user via an external device 9 located on the network 11 (e.g. the internet, through the wifi or a wireless network). In a preferential architecture, the multimedia device 10 can have a private or semi private accessed service interface 34 installed on an ADSL\cable\optical fibre component coupled to the device 10. The service interface 34 (and managed service application layer 30) can be installed in a multimedia component of the multimedia device 10, such as a set-up box. The service interface 34 (and managed service application layer 30) could be also run as a private/public entity when the multimedia device 10, such that the security issues regarding access to the managed service application layer 30 can be managed inside the service interface 34 via the login credentials.

Based on the hardware architecture of the device infrastructure 26 and the type of storage 24 available, the service interface 34 (and managed service application layer 30) could be segregated between a local public access and a local private access, such that the local public access of the managed service application layer 30 is available for sharing, manage or store information requested from a third party device 9. Therefore, the local private access of the managed service application layer 30 can be available to store, share or manage information via the system bus 13 (e.g. data path 40) by the device 10 user.

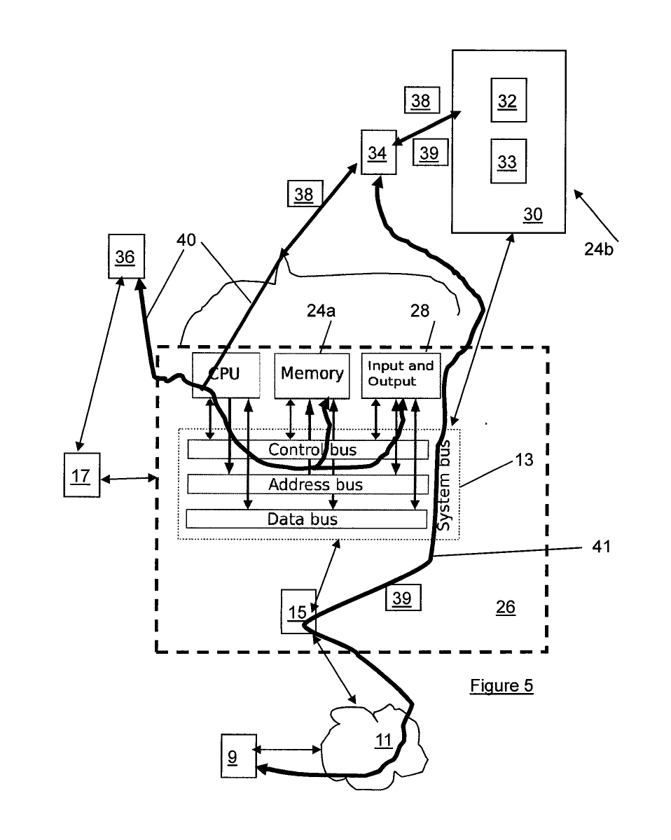

As such, as described above the browser application 36 can be configured as a client to communicate with the service interface 34 via the data path 40 (see FIG. 2). The browser application 36 can be configured to communicate as a client with the external devices 9 via the data path 41 (see FIG. 3). As shown in FIG. 5, in a hybrid configuration, the browser application 36 can be configured to communicate with the service interface 34 via the data path 40 to receive content 38 while at the same time the service interface 34 can be configured to communicate with the external device(s) 9 via the data path 41 to receive content 39 that can be integrated with content 38 and provided as such to the browser application 36 via the data path 40. In this manner, the browser application 36 could receive data originating from the external device(s) 9 without being a client of the external device(s) 9, rather by being a client of the service interface 34 via the data path 40 that bypasses the network connection interface 15.

Further, it is recognized that the service interface 34 can be configured to provide the service resources 38 to the browser application 36 via the data path 40 (see FIG. 2). The service interface 34 can also be configured to communicate and obtain the network resources 39 from the external devices 9 via the data path 41 (see FIG. 3). As shown in FIG. 5, in a hybrid configuration, the service interface 34 can be configured to communicate with the browser application 36 via the data path 40 to provide content 38 while at the same time the service interface 34 can be configured to communicate with the external device(s) 9 via the data path 41 to receive content 39 that can be integrated with content 38 and provided as such to the browser application 36 via the data path 40. In this manner, the service interface 34 could receive external data 39 originating from the external device(s) 9 as a client of the external device(s) 9, and then provide as a service such external data 39 as data 38 to the client browser application 36 (of the service interface 34) via the data path 40 that bypasses the network connection interface 15.

In this manner, the service interface 34 can be configured to be both a client of the external device 9 as connected by the data path 41 via the network connection interface 15 of the device infrastructure 26 and to be configured as a service to the client browser application 36 connected by the data path 40 that bypasses the network connection interface 15 of the device infrastructure 26. For example, the client browser application 36 (of the service interface 34) could request (via the service interface 34) data content from one of the service applications 32 via data path 40, such that the requested data content would be provided as data content 38 comprising an aggregate of data 33 obtained from data stored in the service application layer 30 and information resource(s) 39 obtained from the external device 9 via data path 41. As such, upon receiving the data content request from the client browser application 36, the service interface 34 would be configured to fulfill the data content request as content 38 using both stored data 33 obtained from the storage 24b and requested data 39 via the data path 41 obtained by the service interface 34 being a client of the external device 9.

As such, an advantage of the local cloud service architecture (e.g. the service interface 34 and managed service application layer 30) is that the local cloud is integrated in the overall software architecture (of the multimedia device 10) sitting on top of the operating system 17 and associated device infrastructure 26. As such, the service applications 32 of the managed service application layer 30 can communicate with the main device applications 20 hosted by the multimedia device 10 via the service interface 34 (e.g. Data broker). The device applications 20 hosted by the multimedia device 10 could be video streaming, Internet access services, and video on demand, and others. It is also advantageous that the service interface 34 and managed service application layer 30 are supported by the software main frame (e.g. operating system 17 and associated device infrastructure 26) used by the multi media device 10 and its local device applications 20 of the device application layer 22. The software of device 10 (e.g. operating system 17) could be Linux, Windows or Android or other proprietary Operating System.

As can be seen in FIG. 1, the local cloud can have components of the data broker and the cloud services Layer (e.g. service interface 34), the service applications layer 30, and the databases of the storage 24b. For example, the data broker functionality of the service interface 34 can be in charge to send or receive requests from the client browser 36, from other device applications 20 hosted by the multimedia device 10 and from the service applications 32 hosted in inside the service application layer 30. The data broker functionality can also include access to the network connection interface 15 for obtaining data content 39 from the devices 9 over the network 11. The service application layer 30 can be defined as a repository for the service applications 32 hosted by the local cloud (e.g. service interface 34), such that these applications 32 could be multimedia applications, services applications or even productivity applications. The local cloud applications of the service application layer 30 could be available by the device 10 user or/and by the public (e.g. via devices 9) based on user access credentials and the settings configuration administered by the service interface 34. For example, failure to provide approved user access credentials by the client browser application 36 or by the client device 9 would result in access denial to the service applications layer 30 by the requesting client. The cloud services layer of the service interface 34 can be in charge of managing the device 10 related resources and associated functionality of the local cloud, such database 24b management, the user credentials acceptance or rejection, the application 32 updates and management, the memory 24b management. As such, the cloud services layer can be configured as a back-end service of the data broker and the cloud services layer could be compatible to a cloud service layer used by a service 7 implemented on an external device 9 of the network 11. The databases of the storage 24b can be used to store the service resources 32,33 accessed by the service application layer 30. The service resources 32,33 could be files, relational databases, encrypted information, for example. The databases of the storage 24b could be available only to authorized users but also to the public, based on user supplied credentials. The access to the databases of the storage 24b can be managed by the Cloud services layer of the service interface 34. In some configurations, the databases of the storage 24b also be managed directly via the service application layer 30 and/or one of the device applications 20 hosted in the multimedia device 10 for that purpose.

In view of the above, it is apparent that client devices 9 could use the local cloud of the data broker and the cloud services Layer (e.g. service interface 34), the service applications layer 30, and the databases of the storage 24b as a remote service architecture accessible over the network 11 to access any service resources 32,33. In this configuration, the device 10 would be configured as a server to the client device 9. Alternatively, it is apparent that client of the local cloud could be the browser application 36 (or any other device application 20), such that the device application 20 is run as a client of the service interface 34 through the data path 40. As such, local cloud service resources 32,33 could be available to the device application 20 in a communication data path 40 that bypasses the network 11.

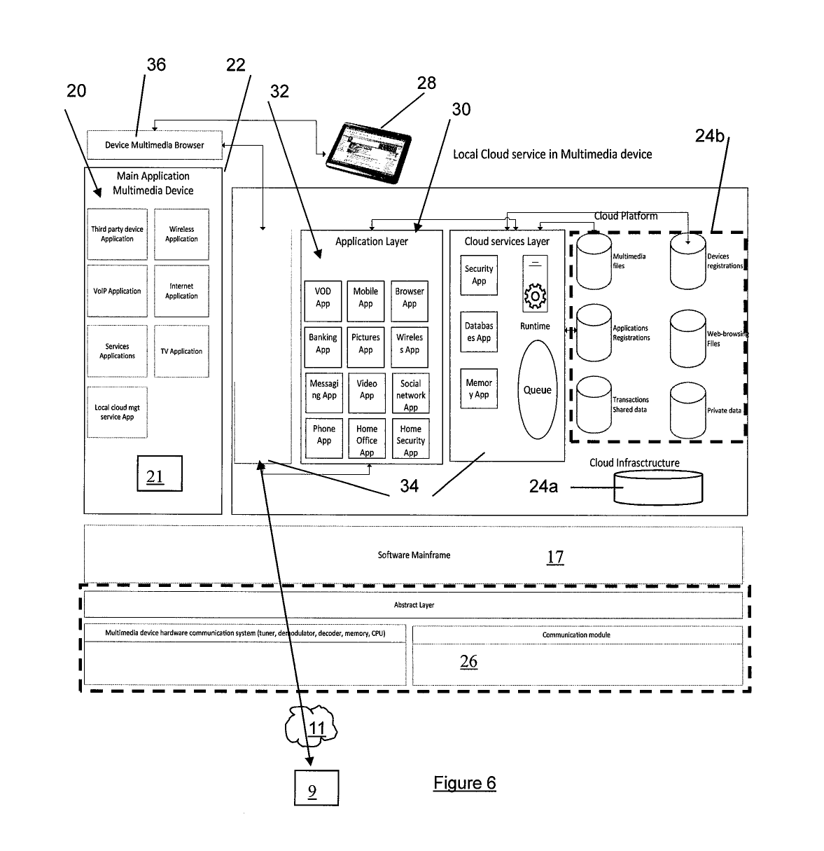

Referring to FIG. 6, shown is an example of Local cloud multimedia data workflow, e.g. video visualization. The local cloud has the ability to store 24b and manage all the video 32,33 owned by the user, such that these video's can be made available to the device user interface 28 and/or other devices 9 (e.g. the TV, a smart phone, a table PC or a laptop) connected via the network 11. An example operation of the service interface 34 configured as a service can be as follows. 1) The user connects to the service interface 34 through the local browser 36 (via data path 40—see FIG. 2) or the multimedia device 9 (via data path 41—see FIG. 3)—such that when the user uses his device 9 to access the service interface 34, the user is using the device 9 multimedia browser which could be an Internet browser (IE, Chrome, Firefox etc) or it could be the specific device application 20 (e.g. browser 36) hosted by the application layer 20 of the multimedia device 10. 2) The browser (e.g. browser 36) obtains access to the local cloud application layer 30 through the data broker of the service interface 34 (for example by providing approved access credentials). 3) The user is connected to the video application 32 inside the local cloud application layer 30, as brokered by the service interface 34 (e.g. browser communicates with the service interface 34 and the video application 32 also communicates with the service interface 34, such that any service resources 32,33 are passed between the application 32 and the browser via the service interface 34). 4) The video application 32 gives to the user access of all the public video data 33 stored in the cloud application layer 30 (e.g. the user can search, browse or pre-visualize the video data 33). Further, the user can have access to some specific rendering or services available inside the video application 32 (based on user credentials) such as adding some comments, parental restrictions access, make available the video data 32 to somebody outside the service interface 34. 5) The video application 32 uses the cloud service layer of the service interface 34 to access the video databases or repository 24b, based on the cloud service layer control of the user credentials and the security settings (e.g. public vs. private data 33 access). 6) If the user chooses to visualize a video 33, the file is pushed to a queue (not shown) of the service interface 34 and the user can start streaming the video 33 on the user interface (e.g. user interface 28). In this manner, the service interface 34 can provide access to the service resources 32,33 by putting the requested service resources 32,33 in the service resource queue of the service interface 34. 7) If the user switches from his browser to another device 9 (e.g. TV) in order to have a better rendering of the video, the user can do so via the TV browser or main application in a set-up box connected to the W. In both cases, the set-up box or the embedded TV browser can grab the video 33 inside the queue and make it available to the different device 9 (e.g. TV). 8) In the meantime the video 33 is still available for the original access browser (e.g. browser application 36). As described by example, the local cloud is acting as a video streaming service for the browser (e.g. multimedia devices 9, browser 36) connected as a client to the local cloud either via the data path 40 or the data path 41.

Depending on the computing service (e.g. data processing, data access, etc.) that the service interface 34 offers, the service interface 34 could be configured as a service as a database server, a file server, a mail server, a print server, a web server, a gaming server, a video server or some other kind of server. In the context of client-server architecture, the service interface 34 can be defined as a computer program running to serve the requests of other programs, the “clients”. Thus, the “server” function of the service interface 34 performs some computational task (including data access to data 32,33 accessible via the service interface 34—e.g. in server storage 24b) on behalf of “clients” (e.g. browser 36 and/or device 9). In the present context, the client (coordinating the access and communication with the server) can be run on the device 10 and/or can be run on the device 9 and connect through the network 11 with the service interface 34 affiliated with the service applications 32. It is recognized that the relationship of the client application with it's affiliated server service interface 34 is typically done on a one-to-one basis, such that a client application affiliated with one server service interface 34 is not configured as client of a different server service interface 34 (e.g. the client application affiliated with the service interface 34 may not be a client of a different server).

It is also recognized that a device 10 (e.g. desktop, mobile device, etc.) can be configured as service interface 34 or otherwise be configured to act as service interface 34 in communication with another device 9 over the network 11 and/or browser 36 via the system bus 13. As such, the service interface 34 is capable of acting as a network server for the device 10 and the device 10 can contain features (e.g. hardware, software, network connectivity) making the device suitable for production environments. These features can include a faster CPU, increased high-performance RAM, and increased storage capacity in the form of a larger or multiple hard drives, as compared to such features typically had by personal computer devices 10. However, as discussed, it is recognized that personal computer device 10 can be configured (e.g. on the network 11) to communicate as a server (e.g. service interface 34) with an affiliated client application on another personal computer device 9 on the network 11.

As such, it is recognized that the local cloud services (e.g. as brokered by the service interface 34) could be connected to the external network 11, e.g. a global cloud. The global cloud can provide services, updates, interfaces or data content 39 to the service interface 34, for receipt by one or more service applications 32. The Global cloud could be an interface between public websites, web applications or any kind of third party web applications and with the local cloud administered by the service interface 34. The global cloud can provide secure access to the local cloud or can format requests between the local cloud and third party web applications. The global cloud can be a standard cloud service with the same type of services such as Amazon or Google cloud services, such that a difference with the current cloud services available is that it has an optimized access to all local clouds using the local cloud architecture brokered by the service interface 34.

### Example Operation of the Service Interface 34

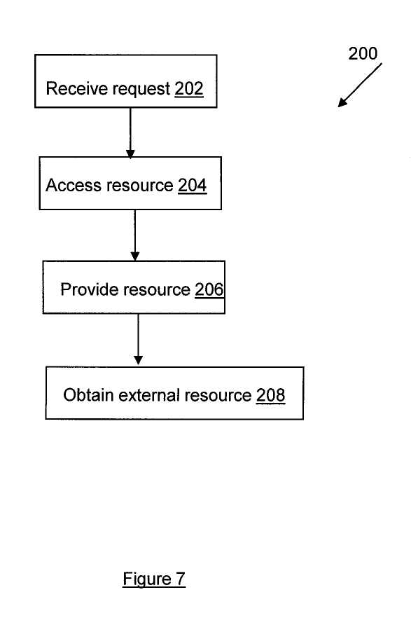

Referring to FIGS. 1 and 7, shown is a method 200 for hosting a service on the device 10, the service configured to provide the information resource 32,33 to a first client, the information resource 32,33 in web compatible format. At step 202 the service interface 34 receives a request for the information resource 32,33 from the device application 20 (e.g. browser 36) hosted by the same device 10 in the device applications layer 22. The device application 20 can act as the client of the service interface 34 (e.g. once user credentials have been submitted by the device application 20 and approved by the service interface 34). The request is communicated to the service interface 34 on the communication data path 40 (see FIG. 2) that bypasses the network connection interface 15 of the device infrastructure 26 of the device 10. At step 204, the service interface 34 accesses the service application layer 30 stored on the device 10 in the storage 24b in order to obtain the information resource 32,33. At step 206, the service interface 34 provides the information resource 32,33 in a response to the client (e.g. device application 20) for subsequent processing and display on the user interface (e.g. user interface 28). Alternatively, the client could be the external device 9 and therefore communicated as a response via the data path 41 (see FIG. 3). For example, the service interface 34 is configured as a client of a service provided by the external device 9 and/or can be configured as a service since the external device 9 is configured as a client of the service interface 34. At step 208, optionally the service interface 34 can obtain an external information resource 39 from the external device 9 (via the data path 41) and provide the external information resource 39 as part of the information resource 32,33 in the response to the device application 20 using the communication data path 40 for the response that bypasses the network connection interface 15.

### Alternative Embodiment of the Service Interface 34

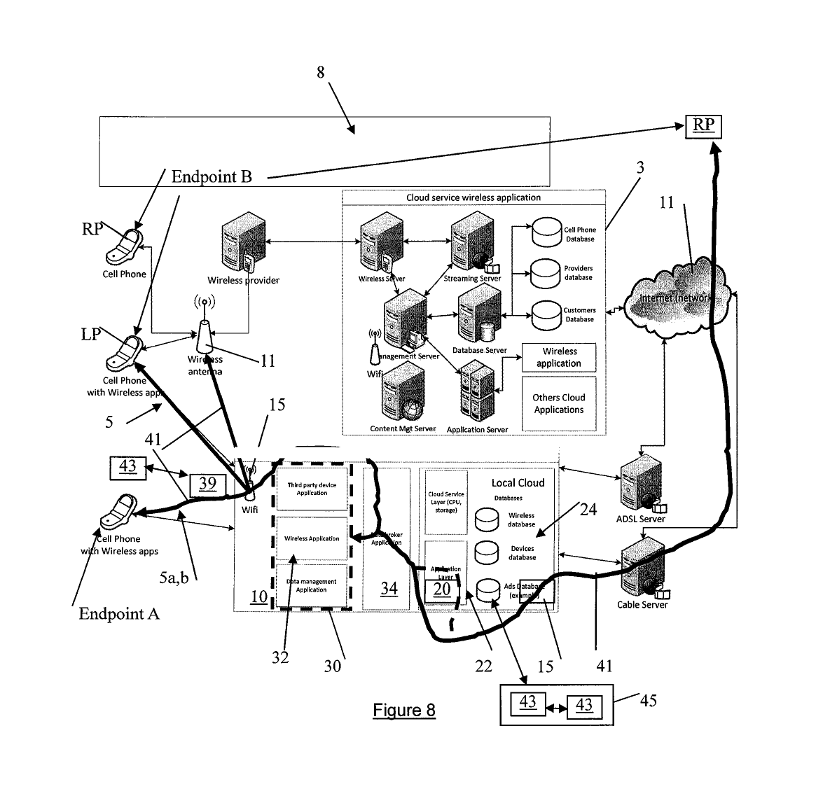

Referring to FIG. 8, shown is the application access environment 8 whereby the external device 9 is a mobile phone (e.g. smart phone) or other wireless communication device. The device 10 makes available the service interface 34 as a wireless communication service for brokering voice and/or text data 39 communicated between the network 11 (e.g. wireless or wired LAN or WAN) and the external device 9 configured as a client of the service interface 34. For example, the device 10 (via the service interface 34) can be used by the client external device 9 as a proxy to the network 11. The service application 32 for coordinating wireless communication (e.g. transfer of content 39) with the external client device 9 can be a “Wireless Application” as shown.

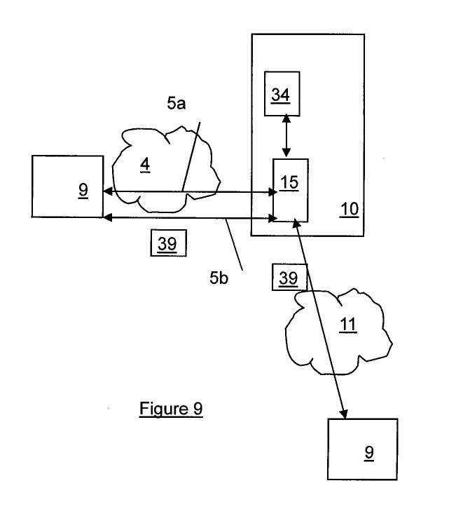

One example is where the service interface 34 brokers the transfer of data content 39 (e.g. voice or text/image data content) between the external client device 9 and a locally connected network phone LP (e.g. via a local wireless network 5a such as Wifi, Bluetooth or RFID—e.g. LAN—see FIG. 9), such that the data content 39 is ultimately exchanged (via the device 10) between the client device 9 and the locally connected network device LP whereby access to and communication on the local network 5a is independent of administration by a network service provider. For example, the local network 5a can be referred to as a short range or local range network 5a, as further discussed below. In this example, the network 11 can be referred to as a long range or remote network 11, as further discussed below, such that the service interface 34 would be using a network 11 connection plan (e.g. voice/data plan) that is subscribed to by the device 10 (e.g. third party wireless provider such as the carrier). Further, the client device 9 and the device 10 would both be using the local wireless network 5a that is unsubscribed to (i.e. service plan independent) by the client device 9 and the device 10. One communication example for use of the networks 5a and 11 is where the client device 9 communicates with the device 10 on a “free” (i.e. network service plan independent) short range network 5a (e.g. Bluetooth, Wifi, RFID, etc.), while the device 10 communicates with the network device 9 on a “fee for service” (i.e. network service plan dependent) remote network 11 (e.g. Internet or other carrier based network). In this manner, the client device 9 obtains an advantage of being able to communicate data content 39 with the remote network device 9 without having to use a network address (and client device 9 service plan associated therewith) on the remote network 11.

A further example is where the service interface 34 brokers the transfer of data content 39 (e.g. voice or text/image data content) between the external client device 9 and a locally connected network phone LP (e.g. also via the wireless network 5b—see FIG. 9), such that the data content 39 is ultimately exchanged (via the device 10) between the client device 9 and the locally connected network device LP whereby access to and communication on the networks 5b,11 are dependent on administration by network service provider(s). For example, the network 11 can be referred to as a long range or remote network 11, as further discussed below. In this alternative example, the service interface 34 would be using a network 11 connection plan (e.g. voice/data plan) that is subscribed to by the device 10 (e.g. third party wireless provider such as the carrier). Further, the client device 9 would also be using another network 5b connection plan (e.g. voice/data plan) that is subscribed to by the client device 9 (e.g. third party wireless provider such as the carrier). Typically, the network 11 connection plan of the device 10 is different from the network 5b connection plan of the client device 9, as network connection plans can be device dependent. One communication example for use of the networks 5b,11 is where the client device 9 communicates with the device 10 on a “local cost” (i.e. network service plan dependent for the client device 9) network 5b (e.g. local call charge rates), while the device 10 communicates with the network device 9 on a “long distance fee for service” (i.e. network service plan dependent for the device 10 at service rate different from the service rate of the network service plan dependent for the client device 9) remote network 11 (e.g. Internet or other carrier based network). In this manner, the client device 9 obtains an advantage of being able to communicate data content 39 with the remote network device 9 without having to use long distance service plan charges associated with client device 9, which can be the case where the long distance service plan (for network 11) of the device 10 has lower rates that the long distance service plan (for network 5b) of the client device 9. Alternatively, the client device 9 may not have a long distance service plan for the network 11 (e.g. the service plan of the client device 9 for network 5b does not have desired long distance rates) and therefore can utilize the long distance service plan for the network 11 of the device 10.

Another example is where the service interface 34 brokers the transfer of data content 39 (e.g. voice or text/image data content) between the external client device 9 and a remotely connected network phone RP (e.g. via a WAN network 11 such as the Internet or other carrier/provider based network utilizing network elements/infrastructure—for example cell phone towers—associated with the carrier/provider), such that the access to and communication on the network 11 is dependent on administration by a network service provider. In this alternative example, the service interface 34 would be using a network 11 connection plan (e.g. voice/data plan) that is subscribed to by the device 10 (e.g. third party wireless provider such as the carrier). Further, the client device 9 would also be using another network 11 connection plan (e.g. voice/data plan) that is subscribed to by the client device 9 (e.g. third party wireless provider such as the carrier). Typically, the network 11 connection plan of the device 10 is different from the network 11 connection plan of the device 10, as the network connection plans are device dependent. Preferably, the network 11 connection plan of the device 10 has lower voice/data rates (or has data communication features—e.g. unlimited text absent from the network 11 connection plan of the client device 9) as compared to the network 11 connection plan of the client device 9.

The network service provider of a network service plan associated with a device 9,10 (or user account of a user of the device 9,10) can be defined as a third party wireless provider or carrier (e.g. a mobile network operator also known as a wireless service provider, wireless carrier, cellular company, or mobile network carrier) who is a provider of wireless communications services, including network 5a,b,11 connections with the device 10 via the appropriate ports of the network connection interface 15. The network service provider can own or control one or more elements of communication infrastructure necessary to sell and deliver network 5b,11 services to the end user (e.g. the devices 9,10) including radio spectrum allocation, wireless network infrastructure, back haul infrastructure, billing, customer care and provisioning computer systems and marketing, customer care, provisioning and repair organizations. In addition to obtaining revenue by offering retail services under its own brand, an the network provider can also sell access to network services at wholesale rates to mobile virtual network operators. A defining characteristic of a mobile network operator is that they own or control access to a radio spectrum license from a regulatory or government entity. A second defining characteristic of a mobile network operator is that the mobile network operator owns or controls the elements of the network 5b,11 infrastructure that are used to provide services to subscribers (e.g. the devices 9,10) over the licensed radio spectrum of the network. A mobile network operator typically also has the necessary provisioning, billing and customer care computer systems and the marketing, customer care and engineering organizations needed to sell, deliver and bill for services to the devices 9,10, however, the can mobile network operator outsource any of these systems or functions and still be considered an mobile network operator.

Alternatively, the network service provider can be defined as an Internet service provider (ISP), for example a cable service provider, which is an organization that provides access to the Internet 5b,11. Access ISPs directly connect the devices 9,10 to the Internet 5b,11 using copper wires, wireless or fiber-optic connections. Hosting ISPs lease server (e.g. devices 10) space for smaller businesses and other people. Transit ISPs provide large amounts of bandwidth for connecting hosting ISPs to access ISPs.

Accordingly, the service interface 34 can be configured to provide the network 5a,b,11 access service to the external client device 9 to facilitate communication of data content 39 (via data path 41) between the external client device 9 located on network 5a,b and other network devices 9 (e.g. LP, RP) located on the network 11 (e.g. having network 11 addresses), such that the data content 39 has network endpoints (e.g. endpoint A and endpoint B) corresponding with network addresses 43 of the devices 9 (e.g. client device 9 and local/remote network devices LP, RP), whereby the endpoint A is on network 5a,b and endpoint B is on the network 11 and the service interface 34 of the device 10 is configured to broker (e.g. acting as a network proxy) the exchange of data content 39 between the different devices 9 located on different networks 5a,b,11. As such, network communications of the data content 39 includes network addresses 43 of the client/network devices 9 and the device 10 on the networks 5a,b,11, such that data content 39 originating from client device 9 contains network addresses 43 of the device 10, the transmission endpoint A (of the client device 9) and the destination endpoint B (of network device 9) to facilitate transmission over the network 11, while data content 39 originating from external network device(s) 9 contains network addresses 43 of the device 10 and the transmission endpoint B (e.g. network device 9). Therefore, it is the role of the service interface 34 (and supporting service application layer 30) to intercept and broker the communication of the data content 39 between the client device 9 and the network device 9, such that the service interface facilitates (e.g. via a communication service application 32—wireless application) appropriate addressing of the data content 39 on the network 5a,b and the network 11. Further, it is recognized that the external network devices 9 (referred to as LP and RP) do not have to be clients of the service interface 34, as they can communicate the data content 39 by treating the device 10 just as any other network device on the network 11.

### Example Short Range Networks 5a

Referring to FIG. 9, the network 5a can be referred to as a dedicated short range communication (DSRC) channel, incorporating the use of electromagnetic or electrostatic coupling in the radio frequency (RF) portion of the electromagnetic spectrum 4 to uniquely identify and communicate with devices 9,10 in electromagnetic spectrum 4 range of one another (e.g. Bluetooth, RFID, Wifi, etc.). As noted above, the device 10 is configured for communicating with the client devices 9 when they are present in the electromagnetic spectrum 4 in communication range of the wireless local communication capabilities of the network connection interface 15, such that the communication of the data content 39 between the device 10 and the client devices 9 use direct radio frequency signals to send and receive the data content 39. For example, to connect to devices 9,10 via the local wireless network 5a (e.g. WLAN), the computer device 9,10 is equipped with a wireless network interface controller 15 configured to receive and broadcast wireless communication signals when in range in the spectrum 4 shared by the devices 9,10. The combination of the computer device 9,10 and interface controller 15 can be called a station. All stations (e.g. computer device 9,10) can share a single radio frequency communication channel within the spectrum 4, such that transmissions of the data content 39 on this channel are received by all stations (e.g. computer device 9,10) within range of one another. The hardware of the interface controller 15 may not signal to the sending device 9,10 the transmission of the data content 39 was delivered to the receiving device 9,10 and is therefore the network 5a can be called a best-effort delivery mechanism. A carrier wave of the spectrum 4 is used to transmit the content data 39 in packets, which can be referred to as “Ethernet frames”. Each station (e.g. computer device 9,10) via the respective network connection interface 15 is constantly tuned in on the radio frequency communication channel of the spectrum 4 in order to pick up available transmissions of the data content 39 broadcast in the spectrum 4 with range of the broadcasting device 9,10.

In terms of Bluetooth, Bluetooth is one example of the electromagnetic spectrum 4 used by the short range network 5a as a wireless technology that allows short range communications between Bluetooth enabled computing devices 9,10. Bluetooth enabled computing devices 9,10 can include portable and/or fixed computing devices. Accordingly, Bluetooth provides short range radio communications between computing devices 9,10 located within a predefined physical range in the electromagnetic spectrum 4. Typically, the short range of Bluetooth technology is application specific and can be pre-defined. Bluetooth can operate in the 2.4 GHz ISM radio frequency band. Typically, Bluetooth computing devices 9,10 can operate in a master-slave (e.g. client-server) configuration such that a master Bluetooth computing device can communicate with a number of slave computing devices (i.e. within a piconet or Bluetooth communication network of devices). In turn each of the slave computing devices can act as a master within a separate piconet and connect to a number of designated devices. Bluetooth communication on the network 5a can include authentication means and discovery protocols for discovery of each other (e.g. adjacent Bluetooth computing devices 9,10 in spectrum 4 range of one another). In yet another mode, users of different Bluetooth computing devices 9,10 can authenticate with one another prior to communication of the data content 39 by exchanging a password or PIN number between one another after which the connection on the network 5a can be established.

For example, to connect to a Bluetooth enabled network 5a, the computer device 9,10 is equipped with a Bluetooth configured network interface controller 15 configured to receive and broadcast wireless Bluetooth communication signals when in range in the Bluetooth spectrum 4. The combination of the computer device 9,10 and Bluetooth interface controller 15 can be called a station. All Bluetooth stations (e.g. computer device 9,10) can share a single radio frequency communication channel within the Bluetooth spectrum 4, such that transmissions of the data content 39 on this Bluetooth channel are received by all Bluetooth configured stations (e.g. computer device 9,10) within range of one another. The hardware of the Bluetooth interface controller 15 may not signal to the sending Bluetooth device 9,10 the transmission of the data content 39 was delivered to the receiving Bluetooth device 9,10 and therefore the Bluetooth network 5a can be called a best-effort delivery mechanism. A carrier wave of the Bluetooth spectrum 4 can be used to transmit the content data 39 in packets. Each Bluetooth station (e.g. computer device 9,10) via the respective Bluetooth network connection interface 15 is constantly tuned in on the radio frequency communication channel of the Bluetooth spectrum 4 in order to pick up available transmissions of the data content 39 broadcast in the Bluetooth spectrum 4 with range of the broadcasting Bluetooth device 9,10.

In terms of RFID, RFID is another example of the electromagnetic spectrum 4 used by the short range network 5a as a wireless technology that allows short range communications between RFID enabled computing devices 9,10. Examples of the spectrum 4 accessed by the device 10 through the network connection interface 15 (e.g. antenna) can include: frequencies 30 KHz to 500 KHz having short transmission ranges (generally less than six feet); and frequencies 850 MHz to 950 MHz and 2.4 GHz to 2.5 GHz offering longer transmission ranges (e.g. more than 90 feet). There are many different versions of RFID that operate at different radio frequencies. The choice of frequency can be dependent on the requirements of the application. In particular, three primary frequency bands have been allocated for RFID use. Low Frequency (125/134 KHz) is most commonly used for access control and asset tracking. Mid-Frequency (13.56 MHz) is most commonly used where medium data rate and read ranges are needed. Ultra High-Frequency (850 MHz to 950 MHz and 2.4 GHz to 2.5 GHz) offers the longest read ranges and highest reading speeds.

For example, to connect to a RFID enabled network 5a, the computer device 9,10 is equipped with a wireless RFID network interface controller 15 configured to receive and broadcast wireless communication signals when in range in the RFID spectrum 4. The combination of the computer device 9,10 and RFID interface controller 15 can be called a RFID station. All RFID stations (e.g. computer device 9,10) can share a single radio frequency communication channel within the RFID spectrum 4, such that transmissions of the data content 39 on this channel are received by all RFID stations (e.g. computer device 9,10) within range of one another. The hardware of the RFID interface controller 15 may not signal to the sending RFID device 9,10 the transmission of the data content 39 was delivered to the receiving RFID device 9,10 and is therefore the network 5a can be called a best-effort delivery mechanism. A carrier wave of the RFID spectrum 4 is used to transmit the content data 39 in packets. Each RFID station (e.g. computer device 9,10) via the respective RFID network connection interface 15 is constantly tuned in on the radio frequency communication channel of the RFID spectrum 4 in order to pick up available transmissions of the data content 39 broadcast in the RFID spectrum 4 with range of the broadcasting device 9,10.

In terms of Wifi, Wifi is another example of the electromagnetic spectrum 4 used by the short range network 5a as a wireless technology that allows short range communications between Wifi enabled computing devices 9,10. Wifi communication over the spectrum 4 provides for the electronic devices 9,10 to exchange data wirelessly (using locally transmitted and received radio waves) as the computer network 5a. Wifi communications over the network 5a can be defined as any wireless local area network (WLAN) communications that are based on the Institute of Electrical and Electronics Engineers' (IEEE) 802.11 standard. The devices 9,10 that can use Wifi (such as a personal computer, video-game console, smart phone, tablet, or digital audio player) can connect to one another via a wireless network access point of the network 5a. Such an access point (or hotspot) has a spectrum 4 range of about 20 meters (65 feet) indoors and a greater range outdoors. Hotspot coverage of the spectrum 4 of the network 5a for Wifi can comprise an area as small as a single room with walls that block radio waves or as large as many square miles (achieved by using multiple overlapping access points—for example many devices 10 in communication with one another in a chain of devices such that the client device 9 connects with the device 10 at one end of the chain of devices 10 and the network device 9 connects with another device 10 at the other end of the chain of devices 10).

For example, to connect to a Wifi enables network 5a (e.g. WLAN), the computer device 9,10 is equipped with a wireless Wifi network interface controller 15 configured to receive and broadcast wireless communication signals when in range in the Wifi spectrum 4. The combination of the computer device 9,10 and Wifi interface controller 15 can be called a Wifi station. All Wifi stations (e.g. computer device 9,10) can share a single radio frequency communication channel within the Wifi spectrum 4, such that transmissions of the data content 39 on this channel are received by all Wifi stations (e.g. computer device 9,10) within range of one another. The hardware of the Wifi interface controller 15 may not signal to the sending Wifi device 9,10 the transmission of the data content 39 was delivered to the receiving Wifi device 9,10 and is therefore the Wifi network 5a can be called a best-effort delivery mechanism. A carrier wave of the Wifi spectrum 4 can be used to transmit the content data 39 in packets, which can be referred to as “Ethernet frames”. Each Wifi station (e.g. computer device 9,10) via the respective Wifi network connection interface 15 is constantly tuned in on the radio frequency communication channel of the Wifi spectrum 4 in order to pick up available transmissions of the data content 39 broadcast in the Wifi spectrum 4 with range of the broadcasting Wifi device 9,10.

In view of the above, it is understood that the radio signal emitted by the network connection interface 15 of the 10 sends the data content 39 to the client device 9 present in the spectrum 4, providing for communications on the short range network 5a. As such, the devices 10 include the RF configured connection interface 15, such as a transceiver/receiver with an optional wired/wireless network interface card or a modem, coupled via connection (e.g. system bus 13) to the device infrastructure 26—see FIG. 2. The connection interface 15 is connectable during operation of the device 10 to the network 5a by wireless links (e.g., RF, IR, etc.) in the spectrum 4, which enables the devices 9,10 to communicate with each other via the network 5a for intercommunication of the data content 39 as well as operational features of the devices 9,10 (e.g. operating system upgrades, file system upgrades, etc.).

### Example Configuration of Service Interface 34

Referring to FIG. 8, the following is an example of the configuration of the service interface 34, in which the destination endpoint (e.g. endpoint B) address 43 of an external network device 9 on the remote network 11 is associated with data content 39 originated by the client device 9 on the local network 5a,b. In this manner, the device 10 is configured to receive the data content 39 from the client device 9 on the local network 5a,b via the service interface 34, as addressed to the device 10 (e.g. network 5a address of the device 10) and including the destination endpoint network address 43 of the destination endpoint (e.g. endpoint B) of the network external device 9. In turn, the device 10 (via the service interface 34) is configured to transform or change the destination address of the received data content 39 from that of the network 5a address of the device 10 to that of the network device 9 (e.g. endpoint B) on the network 11, and then communicate the data content 39 on the remote network 11 to the network device 9.

In turn, the device 10 is configured to receive the data content 39 from the network device 9 on the remote network 11 via the service interface 34, as addressed to the device 10 (e.g. network 11 address of the device 10) and including a device identification of the client device 9 (e.g. destination endpoint network address 43 of the destination endpoint—e.g. endpoint A). It is recognized that the device identification can include a device ID of the client device 9 that uniquely identifies the client device 9 to the device 10, so that the service interface 34 can appropriately repackage and send the received data content 39 (from the network device 9) to the appropriate client device 9 over the network 5a,b. Accordingly, the device 10 (via the service interface 34) is configured to transform or change the destination address of the received data content 39 from that of the network 11 address of the device 10 to that of the client device 9 (e.g. endpoint A) on the network 5a,b, and then communicate the data content 39 on the network 5a,b to the client device 9.

In one embodiment, the service interface 34 accesses the wireless service application 32 to provide the destination endpoint (e.g. endpoint B) address 43 and to optionally configure/format the content 39 for transmission and receipt by the external network device 9 (e.g. LP, RP) at the destination endpoint (e.g. endpoint B) address 43 on the network 11. In this manner, the wireless service application 32 is informed of data content 39 communications between the client device 9 and the network device 9, such that any incoming communications 39 from the client device 9 are mapped by the application 32 to the destination endpoint (e.g. endpoint B) address 43 of the external network device 9, and any incoming communications 39 from the network device 9 are mapped by the application 32 to the destination endpoint (e.g. endpoint A) address 43 of the external client device 9. As such, the service application 32 can handle a mapping 45 (e.g. stored in storage 24) between destination endpoint addresses 43 based on a known pairing between the external client device 9 and the external network device 9 (e.g. LP, RP). It is also recognized that the service application 32 can include data content 33 (e.g. from storage 24b) to the data content 39, such that the data content 33 is forwarded to the network device 9 associated with the destination endpoint addresses 43 obtained from the received data content 33 from the client device 9. A such, the mapping can be paired device identifications that uniquely define for the device 10 which device 9 (client or network) the received data content 39 should be retransmitted to.

Therefore, once the data content 39 is received from the client device 9, the service interface 34 registers the client device 9 with the service application 32 (e.g. sets up the mapping 45) and then can contact a device application 20 (e.g. a VOIP application, a wireless phone application, etc.) and passes the data content 39 and destination endpoint address 43 of the network device 9 (e.g. endpoint B) to the device application 20. The device application 20 then communicates data content 39 (and/or optionally data content 33) with the network device 9 by sending the data content 39 (and/or optionally data content 33) via the network connection interface 15 to the destination endpoint address 43 of the network device 9 on the network 11. The device application 20 and/or the service application 32 also includes in the outgoing data content 39 (and/or optionally data content 33) the network address 34 of the device 10 on the network 11 as the return network address 34 for any data content 39 originating from the network device 9 (e.g. in response to data content 39 received as originating from the client device 9).

Further, upon receipt of data content 39 originating from the network device 9, i.e. using the device application 20 with the network connection interface 15, the device application 20 forwards the received data content 39 (e.g. including sending endpoint address 43 of the network device 9 on the network 11 and destination endpoint address 43 of the client device 9 on the network 5a,b) originating from the network device 9 to the service interface 34 for interpretation by the service application 32. For example, the data content 39 (and/or optionally data content 33) coming from the client device 9 can be referred to as client content 39 and the data content 39 (and/or optionally data content 33) coming from the network device 9 can be referred to as network content 39.

In turn, the service interface 34 passes the network address(es) or other device unique identifier(s) to the service application 32, which checks the address mapping 45 and addresses the received network content 39 with the destination endpoint address 43 (e.g. endpoint A) associated with the client device 9 on the network 5a,b. Subsequently, the service interface 34 then takes the received network content 39 with the destination endpoint address 43 associated with the client device 9 on the network 5a,b and uses the device application 20 via the network connection interface 15 to send the received network content 39 to the client device 9 over the network 5a,b via the appropriate port (and/or network hardware device) of the network connection interface 15. In this manner, client content 39 and network content 39 are routed between the respective client device 9 and network device 9 on the different and separate networks 5a,b,11, as brokered by the service interface 34. As discussed above, optionally the network device 9 can be in a client-server relationship with the service interface 34 as well. However the service interface 34 is still used as a data broker for facilitating the communication of the client/network content 39 between the respective devices 9.

Alternatively, the service interface 34 can be configured to transfer the data content 39 directly between the service interface 34 (or service application 32) and the network connection interface 15, in a communication path that bypasses involvement of the native device application 20 configured for network 5a,b,11 communications. As such, the following is an example of the configuration of the service interface 34, in which the destination endpoint (e.g. endpoint B) address 43 of an external network device 9 on the network 11 is associated with data content 39 originated by the client device 9 on the network 5a,b. In this manner, the device 10 is configured to receive the client content 39 from the client device 9 via the service interface 34, such that the client content 39 is communicated on the network 5a,b addressed to the network address 43 of the device 10 and also includes the unique device identifier (e.g. destination endpoint network address 43) of the destination endpoint (e.g. endpoint B) of the network external device 9 on the network 11.

The service interface 34 accesses the wireless service application 32 to provide the destination endpoint (e.g. endpoint B) address 43 and to optionally configure/format the client content 39 for transmission and receipt by the external network device 9 (e.g. LP, RP) at the destination endpoint (e.g. endpoint B) address 43 on the network 11. In this manner, the wireless service application 32 is informed of client content 39 communications between the client device 9 and the network device 9, such that any incoming communications 39 from the client device 9 are mapped by the application 32 to the destination endpoint (e.g. endpoint B) address 43 of the external network device 9, and any incoming communications 39 from the network device 9 are mapped by the application 32 to the destination endpoint (e.g. endpoint A) address 43 of the external client device 9. As such, the service application 32 can handle the mapping 45 (e.g. stored in storage 24) between destination endpoint addresses 43 based on a known pairing between the external client device 9 and the external network device 9 (e.g. LP, RP), via the device unique identifiers. It is also recognized that the service application 32 can include data content 33 (e.g. from storage 24b) to the data content 39, such that the data content 33 is forwarded to the network device 9 associated with the destination endpoint addresses 43 obtained from the received data content 33 from the client device 9.

At the beginning (e.g. initiation of a call to the network device 9 by the client device 9), once the data content 39 is received from the client device 9, the service interface 34 registers the client device 9 with the service application 32 (e.g. sets up the mapping 45) and then contacts network connection interface 15 and passes the data content 39 and destination endpoint address 43 of the network device 9 (e.g. endpoint B) to network connection interface 15. The network connection interface 15 then communicates data content 39 (and/or optionally data content 33) with the network device 9 by sending the data content 39 (and/or optionally data content 33) via the network connection interface 15 to the destination endpoint address 43 of the network device 9 on the network 11. The network connection interface 15 and/or the service application 32 also includes in the outgoing data content 39 (and/or optionally data content 33) the network address 34 of the device 10 as the return network address 34 for any data content 39 originating from the network device 9 (e.g. in response to data content 39 received as originating from the client device 9).

Further, upon receipt of data content 39 originating from the network device 9, i.e. using the network connection interface 15, the network connection interface 15 forwards the received data content 39 (e.g. including sending endpoint address 43 of the network device 9 on the network 11 and unique device identifier of the client device 9) originating from the network device 9 to the service interface 34 for interpretation by the service application 32. For example, the data content 39 (and/or optionally data content 33) coming from the client device 9 can be referred to as client content 39 and the data content 39 (and/or optionally data content 33) coming from the network device 9 can be referred to as network content 39.

In turn, the service interface 34 passes the network address(es) to the service application 32, which checks the device mapping 45 and addresses the received network content 39 with the destination endpoint address 43 (e.g. endpoint A) associated with the client device 9 on the network 5a,b. Subsequently, the service interface 34 then takes the received network content 39 with the destination endpoint address 43 associated with the client device 9 and uses the network connection interface 15 to send the received network content 39 to the client device 9 over the network 5a,b. In this manner, client content 39 and network content 39 are routed between the respective client device 9 and network device 9. As discussed above, the network device 9 can be optionally in a client-server relationship with the service interface 34 as well. However the service interface 34 is still used as a data broker for facilitating the communication of the client/network content 39 between the respective devices 9.

In view of the device 9 examples as wireless devices, one advantage of the configured service interface 34 is to provide network 5a,b access (e.g. to voice/data and/or Internet features) for any wireless client device 9 (e.g. mobile phone) in communication with the device 10 (e.g. in the local wireless range of the device 10) while relying upon connections to a network service provider of the device 10 (rather than those of the client device 9) to send data content 39 over the network 11 to the network device 9. As such, the service interface 34 can be so configured, so as to facilitate providing the data content 39 (e.g. voice functions and Internet function) to any client mobile phones 9 using a network service plan of the device 10 (rather than the client device 9) for network 11 communications with the network device 9 (e.g. LP, RP). Further, the service interface 34 can be configured to provide some information and some data (e.g. services 32 and/or data 33 of the service application layer 30) made available by the device 10 to any client device 9 connected (e.g. in LAN wireless range) of the device 10 over network 5a,b.

As such, use of the service interface 34 as configured for data content 39 communication between the client and network devices 9 can help address leveraging the new generation of smart phones having a very broad range of services including the voice, Internet or image and video capture functionality. As such, facilitation of the data content 39 transfer allows for these smart phone services between the wireless network 5a,b and the smart phone. Therefore, issues with these services can be addressed for the client device 9, such as the saturation of the wireless network or the decrease of the data transfer network speed in some areas, and/or excessive cost of data transfer for the client device 9 customers when communicating with their friends (e.g. network devices 9) directly over the remote network 11. As such, the service interface 34 configured as a data content 39 broker or proxy service can provide a system and method to manage and distribute individual or shared wireless service through a local network 5a,b accessible by any client device 9 connected to the device 10 via the network connection interface 15 (e.g. in wireless Wifi range of a LAN network 5a,b).

### Example Revenue Share Models

The service interface 34 configuration can include components given by below in order to manage data content 39 communication including voice and Internet access through the device 10 with network 5a,b and network 11 capabilities, including the ability to transform addressing of the received data content 39 in order to change the destination address from the device 10 to the respective client device 9 (for data content 39 received from the network device 9) and to change the destination address from the device 10 to the respective network device 9 (for data content 39 received from the client device 9).

The service interface 34 can be configured to: 1) manage receipt and retransmission of wireless phone service (e.g. content 39) through the device 10 network connection interface 15; 2) software architecture of the service interface 34 and/or cooperating service application 32 to manage in call and out call from third party users (e.g. devices 9) of the wireless phone service; 3) global network architecture of the network 11 to support wireless service management through a wifi or wireless enabled device 10; 4) advertising and business model applied to manage business transactions through a individual wireless service; 5) a cloud service wireless application 32 to manage device data communication 39 workflow (transferring the data content 39 between different networks 5a,b,11 as a proxy service); provide for one or more types of a revenue sharing model that apply to the transfer of client content 39 to network content 39 and vice versa in order to provide for payment for each stakeholder:

In terms of the revenue share model, the service interface 34 (and owner thereof) and charge the client device 9 for using the service interface 34 as a network access point for the remote network 11 (i.e. providing the service of brokering the send and receive of the data content 39 over the network 11 on behalf of the client device 9). The revenue obtained by the service interface 34 from the client device 9 in exchange for brokering the send and receive of the data content 39 over the network 11 on behalf of the client device 9 can be shared: 1) between the device 10 Owner, cloud service wireless application infrastructure 3 (e.g. owner or originator of software setup of the service interface 34 and/or service applications 32 of the service application layer 30—see FIG. 1) and third party network 5b,11 service plan provider (e.g. carrier operating or otherwise leasing bandwidth on the network 5b,11); 2) between the device 10 Owner, cloud service wireless application 3 and Internet 11 provider for the device 10 owner; and 3) between the device 10 Owner, loud service wireless application 3 and the device 10 Owner.

### Example Operation of the Service Interface 34

Referring to FIG. 8, description of the workflow between the device 10, the client device 9 (e.g. mobile phone) connected to the local network 5a, the wireless mobile network 5b, the cloud service wireless application 3, and the remote network 11 (e.g. Internet), is given, such that the service interface 34 provides the user of the client device 9 to connect his device 9 to the device 10 equipped with wireless management application(s) 20,32. The client device 9 with Wi-Fi, Bluetooth or RFID network 5a capabilities or through his wireless component network 5b can connect to the local network 5a,b. The local network can be managed by the device 10.

The device 10 can have an internal database 24 in order to recognize the device 9 connected, such that if the device 9 is not yet registered (e.g. having a mapping 45), the to the service interface 34 can request to the Cloud service wireless application database 3 if the device 9 has the credentials to use the wireless application 20,32 capabilities coupled to the service interface 34. When the device 9 gets granted access to the service interface 34, the user of the device 9 can start using as the client device 9 to call, to browse the Internet or use the applications which use a network 11 access via the network connection interface 15 of the device 10. For example, to be able to use the call function, the user of the client device 9 can upload a device application required to call, such as Skype or other VoIP applications available. It could be done directly from the device 10 via the service interface 34 and/or via the cloud service wireless application 3. It is also recognized that based on the evolution of the technology, the client device 9 may be able to use the regular wireless protocol of the network 5b to initiate the communication of data content 39 (e.g. a call) through the network 11.

For example, if the user of the client device 9 wants to initiate a call, the data content 39 is sent via the network 5a,b to the service interface 34, the service interface 34 then transfers the data content 39 to the cloud service wireless application 3, the cloud service wireless application 3 then can manage the data content 39 based on the call recipient (e.g. network device 9) and the type of data content 39 (VoIP, regular voice protocol), the cloud service wireless application 3 can transfer the data content 39 to the user phone provider which could be a mobile provider or a wire line phone provider, if the call recipient is using a VoIP (via laptop or an electronic device), the cloud service wireless application 3 can transfer directly the call through the network 11.

The price of the data content 39 can be based on the duration of the call, the wireless provider, the device 10 used, and the type of services subscribed by the device 9,10 users to use the service interface 34. The cloud service wireless application 3 can calculate the overall cost, and distributes the compensation between the various providers of services (e.g. service plan provider of the network 11 and the owner of the device 10).

The client device 9 can also receive call, whereby the above described workflow is similar. If the client device 9 is connected to the device 10, the data content 39 can be sent to the device 10 by the network device 9 and then brokered by the service interface 34 and then retransmitted to the client device 9 via the network 5a,b. The Cloud service wireless application 3 through the devices 10 database (e.g. network 11 addresses of the various devices 10) is able to target the device 10 on the network 11. Even if the user of the client device 9 switches from one device 10 to another device 10, this information can be sent dynamically to the cloud service wireless application 3 and the cloud service wireless application 3 can reassign the data content 39 workflow to the new device 10. In this case for the revenue share model, the overall cost of the data communication 39 and the compensation can be recalculated from the old device 10 to the new device 10 used by the client device 9 as a network access point to the network 11.

In addition to be able to have access to the voice services and Internet services, the device 10 can also give access to public information through a public web access provided by the service interface 34. Some service applications 32 (and corresponding data 33) can be made available by the service interface 34 in this public web access for all devices 9 in the range of the device 10 network 5a included in the spectrum 4. For example, the public web access could be rented by service providers, such that the cloud service wireless application 3 can provide the cost management application and the compensation management system. It is recognized that the cloud service wireless application 3 can be hosted on a computer system similar to that described in FIG. 4 for the device 10.

Referring again to FIG. 8, the network communication service for the client device 9 can be hosted on the proxy device 10 and configured for facilitating communication of data 33, 39 between the client device 9 of the service 34 on a first network 5a,b and a network device 9 located on a second network 11, the service 34 stored as instructions for execution by a computer processor CPU of the proxy device 10. The service interface 34 of the proxy device 10 is configured to receive client content 39 on the first network 5a,b originating from the client device 9, the client device 9 being a client of the service interface 34, the client content 39 including a sending address 43 endpoint of the client device 9 on the first network 5a,b and a destination address 43 endpoint of the network device 9 on the second network 11, the destination address 43 endpoint associated with a network address of the second network 11. The service interface 34 also accesses a service application layer 30 of the proxy device 10 stored in a first storage 24 in order to identify or otherwise establish a mapping 45 between the address endpoint 43 of the client device 9 and the address endpoint 43 of the network device 9. The service interface 34 and/or the service application 32 (e.g. preferably the service application 32) also configures network transmission data 39 for sending to the destination address 43 endpoint of the network device 9 on the second network 11, the network transmission data 39 including the client content associated with the client device 9 and the destination address 43 endpoint of the network device 9. The service interface 34 sends via a network connection interface 15 of the proxy device 10 the network transmission data 39 to the network device 9 on the second network 11, such that the network transmission data 39 is communicated over the second network 11 using a network service plan for the second network 11 of the proxy device 10.

1. A service hosted on a device configured for providing an information resource to a first client, the information resource in web compatible format, the service stored as instructions for execution by a computer processor of the device to:
receive a request by a service interface of the service for the information resource from a device application hosted by the same device, the device application acting as the first client, such that the request is communicated to the service interface on a communication data path that bypasses a network connection interface of a device infrastructure of the device;
access by the service interface a service application layer stored on the device in a first storage in order to obtain the information resource; and
provide the information resource in a response to the first client for subsequent processing and display on a user interface.

2. The service of claim 1, wherein the device application is a browser application.

3. The service of claim 2, wherein the browser application is one of a plurality of device applications provided in a device application layer stored on the device in a second storage, such that the second storage is segregated from the first storage.

4. The service of claim 3, wherein access to the information resource in the first storage by the browser application is restricted unless said access is brokered by the service interface.

5. The service of claim 3, wherein the service interface is one of the plurality of device applications.

6. (canceled)

7. The service of claim 1 further comprising the service interface configured to communicate with an external device via the network connection interface, the external device located on a communications network connectable to the device infrastructure via the network connection interface.

8. (canceled)

9. (canceled)

10. The service of claim 7, wherein the service interface is configured as a client of a service provided by the external device.

11. The service of claim 10, wherein the service interface is further configured to obtain an external information resource from the external device and to provide the external information resource as part of the information resource provided to the device application using the communication data path that bypasses the network connection interface.

12. The service of claim 7, wherein the service interface is configured as a provider of the service to the external device as a client of the service.

13. The service of claim 12, wherein the service interface provides the information resource to the external device as the first client.

14. (canceled)

15. (canceled)

16. (canceled)

17. (canceled)

18. (canceled)

19. (canceled)

20. (canceled)

21. A method for hosting a service on a device, the service configured to provide an information resource to a first client, the information resource in web compatible format, the method comprising the steps of:
receive a request by a service interface of the service for the information resource from a device application hosted by the same device, the device application acting as the first client, such that the request is communicated to the service interface on a communication data path that bypasses a network connection interface of a device infrastructure of the device;
access by the service interface a service application layer stored on the device in a first storage in order to obtain the information resource; and
provide the information resource in a response to the first client for subsequent processing and display on a user interface.

22. (canceled)

23. (canceled)

24. (canceled)

25. (canceled)

26. A network communication service hosted on a proxy device and configured for facilitating communication of data between a client device of the service on a first network and a network device located on a second network, the service stored as instructions for execution by a computer processor of the proxy device to:
receive client content on the first network originating from the client device by a service interface of the proxy device, the client device being a client of the service interface, the client content including a sending address endpoint of the client device on the first network and a destination address endpoint of the network device on the second network, the destination address endpoint associated with a network address of the second network;
access by the service interface to a service application layer of the proxy device stored in a first storage in order to identify or otherwise establish a mapping between the address endpoint of the client device and the address endpoint of the network device;
configure network transmission data for sending to the destination address endpoint of the network device on the second network, the network transmission data including the client content associated with the client device and the destination address endpoint of the network device; and
send via a network connection interface of the proxy device the network transmission data to the network device on the second network;
wherein the network transmission data is communicated over the second network using a network service plan for the second network of the proxy device.

27. The service of claim 26 further comprising the step of receiving network content originating from the network device by the service interface, the network content including a sending address endpoint of the network device and a destination address endpoint of the client device, the sending address endpoint associated with a network address of the second network.

28. (canceled)

29. The service of claim 26 further comprising the steps of:
configuring client transmission data for sending to the destination address endpoint of the client device; the client transmission data including the network content associated with the network device and the destination address endpoint of the client device; and
sending via a network connection interface of the proxy device the client transmission data to the client device;
wherein the client transmission data is received over the first network using a network service plan for the first network of the proxy device.

30. The service of claim 26, wherein the service interface obtains service data from the service application layer and includes the service data in the network transmission data.

31. The service of claim 26, wherein the service interface obtains service data from the service application layer and includes the service data in the client transmission data.

32. The service of claim 26, wherein the address endpoints are abstracted using a unique device identification of the client device and a unique device identification of the network device, such that the mapping associates each address endpoint of the address endpoints with the respective unique device identification.

33. (canceled)

34. (canceled)

35. (canceled)

36. (canceled)

37. (canceled)

38. The service of claim 26, wherein the first network is a dedicated short range communication channel incorporating the use of electromagnetic or electrostatic coupling in a radio frequency (RF) portion of an electromagnetic spectrum to uniquely identify and communicate with the client device and the proxy device in electromagnetic spectrum range of one another.

39. The service of claim 38, wherein the client device uses the proxy device as a network access point for the second network.

40. The service of claim 26 further comprising the service interface configured to reconfigure the received data content as either the client content of as network content by exchanging the destination network address of the proxy device of the respective content with a respective first network address of the client device for received network content or with a respective second network address of the network device for received client content.

41. (canceled)
